(19) United States
(12) Patent Application Publication
(10) Pub. No.: US 2026/0289896 A1
(43) Pub. Date: Sep. 24, 2026

(54) SYSTEM

(71) Applicant: SoftBank Group Corp., Tokyo (JP)

(72) Inventor: Keisuke KAKUDA, Tokyo (JP)

(73) Assignee: SoftBank Group Corp., Tokyo (JP)

(21) Appl. No.: 19/568,828

(22) Filed: Mar. 17, 2026

(30) Foreign Application Priority Data
Mar. 19, 2025 (JP) 2025-045162

(51) Int. Cl. G06T 15/04; G06F 40/10; G06T 3/40; G06T 15/20; G06V 20/13; G06V 40/16; G10L 25/63

(52) U.S. Cl. CPC G06T 15/04; G06F 40/10; G06T 3/40; G06T 15/205; G06V 20/13; G06V 40/174; G10L 25/63; G06T 2200/04; G06T 2200/08; G06T 2215/16

(57) ABSTRACT

A system includes a processor that is configured to provide a prompt to a generative artificial intelligence model to map two-dimensional texture data acquired from a satellite, generate a realistic three-dimensional model by using the generative artificial intelligence model based on the mapped two-dimensional texture data, and analyze an emotion of a user and adjust a display of the three-dimensional model based on the emotion.

### CROSS-REFERENCE TO RELATED APPLICATION

This application is based on and claims priority under 35 USC 119 from Japanese Patent Application No. 2025-045162 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for generating three-dimensional models from satellite imagery mainly focus on geometric accuracy and visual realism of terrain and structures. However, such techniques generally do not incorporate generative artificial intelligence models to enhance or complete three-dimensional content based on two-dimensional satellite texture data, and do not adapt the generated three-dimensional models in real time to the emotional state or interactive behavior of a user. As a result, known systems are limited in their ability to produce immersive, personalized, and emotionally responsive digital environments. Furthermore, existing solutions often lack an integrated framework that connects satellite-based three-dimensional model generation, emotion-aware visualization, and monetization of digital content through online platforms.

### SUMMARY

In order to solve the above-described problems, a system is provided comprising a processor, wherein the processor is configured to provide a prompt to a generative artificial intelligence model to map two-dimensional texture data acquired from a satellite, and to generate a realistic three-dimensional model by using the generative artificial intelligence model based on the mapped two-dimensional texture data. The processor is further configured to analyze an emotion of a user and to adjust a display of the three-dimensional model based on the emotion, thereby enabling the visualization of the three-dimensional model to be dynamically adapted to the user's emotional state. In addition, the processor is configured to embed the three-dimensional model into digital content and to perform monetization through an online platform, and is further configured to dynamically adjust the display of the three-dimensional model in response to an operation of the user. Through this configuration, the system achieves an integrated pipeline from satellite data to emotionally responsive, interactive three-dimensional content that can be commercially exploited via network-based services.

The term “processor” refers to any hardware or hardware-software combination capable of executing instructions, including but not limited to a central processing unit (CPU), a graphics processing unit (GPU), a digital signal processor (DSP), a microcontroller, an application-specific integrated circuit (ASIC), a field-programmable gate array (FPGA), or a plurality of such elements operating cooperatively.

The term “two-dimensional texture data” refers to image data representing a two-dimensional distribution of color, intensity, or other visual attributes, which is suitable for application onto surfaces of a three-dimensional model as texture information.

The term “two-dimensional texture data acquired from a satellite” refers to two-dimensional texture data obtained from sensors mounted on an artificial satellite, including optical, infrared, or other imaging sensors, and encompassing satellite imagery of terrain, buildings, or other ground features.

The term “generative artificial intelligence model” refers to a computational model, such as a neural network or a machine learning model, that is configured to generate or transform data, including but not limited to images, three-dimensional geometry, or textures, in response to input data or prompts.

The term “prompt” refers to information provided as input to a generative artificial intelligence model, the information including but not limited to text, parameters, image data, or structured data, which guides or constrains the generation or transformation performed by the generative artificial intelligence model.

The term “map” in the context of mapping two-dimensional texture data refers to the operation of associating positions in the two-dimensional texture data with corresponding positions or surfaces of a three-dimensional model, such that the two-dimensional texture data can be applied as a visual texture on the three-dimensional model.

The term “realistic three-dimensional model” refers to a three-dimensional representation of an object, scene, or environment that approximates real-world appearance or structure to a degree sufficient for applications such as visualization, simulation, gaming, or digital twin implementations.

The term “analyze an emotion of a user” refers to detecting or inferring an emotional state of a user based on one or more inputs, including but not limited to facial expressions, voice characteristics, physiological signals, behavioral patterns, or interaction histories, and optionally classifying the emotional state into one or more categories.

The term “display of the three-dimensional model” refers to the visual presentation of the three-dimensional model on a display device, including but not limited to the model's viewpoint, scale, lighting, color, texture, animation, rendering style, or visibility of specific components.

The term “adjust a display of the three-dimensional model based on the emotion” refers to modifying one or more display parameters of the three-dimensional model in dependence on a result of the analysis of the user's emotion, so as to change how the three-dimensional model is visually presented.

The term “digital content” refers to electronically stored or transmitted media, including but not limited to games, simulations, virtual reality or augmented reality experiences, videos, interactive applications, educational materials, and web-based or mobile content.

The term “embed the three-dimensional model into digital content” refers to integrating or incorporating the three-dimensional model as part of the data, scene, or user interface of digital content, such that the three-dimensional model is used, rendered, or interacted with during execution or playback of the digital content.

The term “online platform” refers to a network-based system or service, such as a website, cloud service, marketplace, or distribution platform, that is accessible via a communication network and is configured to distribute, host, or provide access to digital content.

The term “monetization” refers to obtaining revenue or economic value from the use, distribution, or access to digital content, including but not limited to direct sales, subscriptions, licensing fees, advertising revenue, microtransactions, or in-app purchases.

The term “dynamically adjust the display of the three-dimensional model in response to an operation of the user” refers to changing one or more display parameters of the three-dimensional model in real time or near real time, based on user operations such as input via a keyboard, mouse, touch interface, controller, gesture, voice command, or other interaction modalities.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

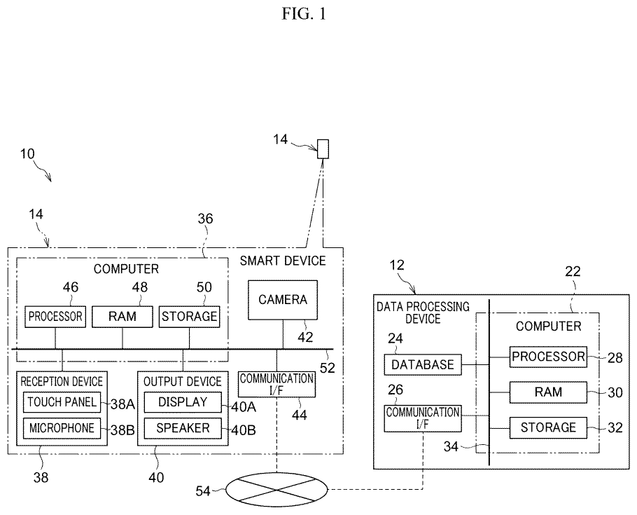

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

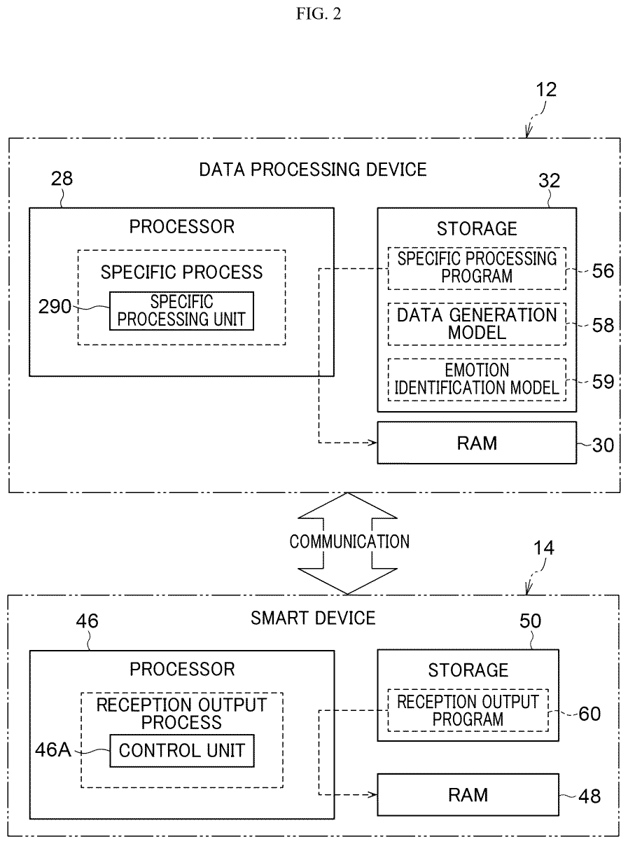

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional techniques for generating three-dimensional content from remote sensing data suffer from multiple deficiencies at the level of core computer processing. In typical workflows, two-dimensional satellite images are manually preprocessed and manually mapped as textures onto three-dimensional meshes using general-purpose graphics tools. These workflows require intensive human intervention for resolution tuning, region cropping, coordinate alignment, and UV mapping, and do not systematically leverage machine learning models to guide or adapt processing. As a result, the processing is brittle, non-reusable, and difficult to scale, and the quality of the resulting three-dimensional representations heavily depends on individual operator skill rather than on objectively optimized computational procedures.

Further, known systems generally treat satellite-derived textures and three-dimensional geometry as separate assets, without a unified control loop that obtains processing procedure information or control parameter information from a generative AI model and feeds this information back into core image-processing and mapping algorithms. In such systems, a generative AI model may provide descriptive guidance at a user-interface level, but it does not programmatically control low-level operations such as projection transformation, coordinate transformation, or texture parameter selection inside the processor. This leads to suboptimal, static parameter settings, poor adaptation to different geographic regions and sensor characteristics, and increased computational waste due to repeated trial-and-error by users.

Additionally, conventional three-dimensional display systems typically do not integrate any robust mechanism for analyzing user behavior information or biometric measurement information during viewing of three-dimensional content. As a result, display conditions such as camera path, level of detail, visual emphasis, or rendering parameters are not automatically adjusted based on an inferred emotional state of the user. This lack of feedback prevents the system from optimizing rendering and interaction at the level of the underlying computing processes and resource allocation, and also limits the effectiveness of the content in terms of engagement and usability.

Moreover, there is insufficient integration between the generation of satellite-based textured three-dimensional models and downstream electronic distribution and monetization on networked platforms. Existing systems often require separate, manual packaging of models, manual metadata assignment, and manual configuration of pricing or usage rights, without tightly coupling these operations to the generated three-dimensional display information within a unified processor-controlled pipeline. This fragmentation results in additional overhead, inconsistency in asset configuration, and difficulty in automating content lifecycle management from acquisition and processing of raw satellite data through to distribution and revenue collection.

Accordingly, there is a need for an improved computer-implemented system that (i) programmatically acquires and preprocesses two-dimensional satellite images into texture information suitable for three-dimensional shape representation, (ii) generates or acquires corresponding three-dimensional shape information, (iii) executes a mapping algorithm to associate the texture information with a three-dimensional surface, (iv) uses a generative AI model, driven by prompt sentences, to supply procedure-level and parameter-level control information back into the preprocessing and mapping algorithms, (v) analyzes user behavior or biometric data to infer user emotional state and adjust three-dimensional display conditions accordingly, and (vi) integrates these capabilities with network-based electronic content management and monetization. Such a system should improve the functioning of the computer itself by reducing human-dependent trial-and-error, enabling adaptive parameter control, enhancing rendering efficiency, and providing a technically integrated pipeline for generation, display, and distribution of high-quality three-dimensional content.

The specific processing by the specific processing unit 290 of the data processing device 12 in Example 1 is realized by the following means.

The present invention provides a server comprising a processor configured to acquire two-dimensional image information obtained by an orbital observation apparatus; to perform, by executing an image processing program, preprocessing on the two-dimensional image information, the preprocessing including at least resolution adjustment and unnecessary region removal, to generate texture information suitable for three-dimensional shape representation; to generate or acquire, by executing a three-dimensional shape generation program, three-dimensional shape information representing object shapes; to execute, by executing a mapping algorithm including projection transformation processing and coordinate transformation processing, a mapping process based on the texture information and the three-dimensional shape information so as to generate three-dimensional display information in which the texture information is associated with a surface of the three-dimensional shape information; to provide input information including at least one prompt sentence to a generative information processing model with respect to the three-dimensional display information or intermediate processing information, to obtain, from the generative information processing model, processing procedure information or control parameter information relating to at least a part of the preprocessing or the mapping algorithm, and to control at least one of the preprocessing and the mapping algorithm based on the obtained processing procedure information or control parameter information; to output three-dimensional video based on the three-dimensional display information to a display apparatus; to analyze user behavior information or biometric measurement information acquired during viewing of the three-dimensional video so as to estimate an emotional state of a user; and to adjust display conditions of the three-dimensional video, including at least one of a viewpoint position, a magnification factor, a display target region, and a display parameter, based on the estimated emotional state and, optionally, to generate electronic information including the three-dimensional display information, to transmit the electronic information to a distribution management apparatus via a communication network, and to associate price information or usage right information with the electronic information for monetization. This enables an improved computer-implemented pipeline in which satellite-derived two-dimensional imagery is automatically converted into high-quality, textured three-dimensional representations under adaptive control of a generative AI model, while the server dynamically adjusts rendering and interaction parameters based on inferred user emotional state and seamlessly packages and distributes the resulting three-dimensional content as monetizable electronic assets via a communication network.

The term “two-dimensional image information” refers to digital data representing a planar arrangement of picture elements, including but not limited to raster images, in which each picture element has at least one intensity or color value, and which is obtained from observation of a physical region.

The term “orbital observation apparatus” refers to any remote sensing apparatus disposed on a trajectory around a celestial body, including but not limited to artificial satellites or spaceborne platforms, and configured to capture observation data such as optical images of a surface region.

The term “preprocessing” refers to a sequence of computational operations applied to raw two-dimensional image information in order to convert the raw information into a form suitable for subsequent analysis or mapping, the operations including at least resolution adjustment and removal of unnecessary regions, and optionally including operations such as noise reduction, radiometric correction, or geometric correction.

The term “resolution adjustment” refers to processing that modifies the spatial sampling or pixel density of two-dimensional image information, including downsampling, upsampling, or resampling to a target resolution, by interpolating or aggregating pixel values.

The term “unnecessary region removal” refers to processing that removes or masks portions of two-dimensional image information that are not required for subsequent use, such as areas outside a region of interest, margins, or pixels corresponding to invalid or irrelevant data.

The term “texture information” refers to processed two-dimensional image information that is formatted and conditioned to be mapped onto a surface of three-dimensional shape information, and that is suitable for use as a texture map in a rendering or visualization process.

The term “three-dimensional shape information” refers to digital data that represents the geometry of one or more objects in three-dimensional space, including at least vertex coordinates, edge definitions, face definitions, or volumetric representations, and which may further include surface normal vectors or other geometric attributes.

The term “three-dimensional shape generation program” refers to a software component or set of instructions executable by a processor and configured to generate or acquire three-dimensional shape information from input data, which may include elevation data, vector data, or predefined geometric models.

The term “mapping algorithm” refers to a computational procedure executed by a processor to associate texture information with three-dimensional shape information, the procedure including at least projection transformation processing and coordinate transformation processing to establish a correspondence between two-dimensional texture coordinates and three-dimensional surface coordinates.

The term “projection transformation processing” refers to mathematical operations that project points or regions from a three-dimensional coordinate space or a geographic coordinate space to a two-dimensional coordinate space, or vice versa, in order to establish a mapping between image coordinates and geometry coordinates.

The term “coordinate transformation processing” refers to computational operations that convert coordinates expressed in one coordinate system into coordinates expressed in another coordinate system, including conversions between geographic, projected, and object-local coordinate systems.

The term “three-dimensional display information” refers to digital data that combines three-dimensional shape information with associated texture information and rendering parameters, and that is suitable for generating three-dimensional video or three-dimensional images when processed by a rendering engine.

The term “generative information processing model” refers to a machine learning model, including but not limited to a generative artificial intelligence model or a generative neural network, that is trained to generate output information such as text, control parameters, or procedure descriptions in response to input information including a prompt sentence.

The term “prompt sentence” refers to input data in a natural language or structured language format that is provided to a generative information processing model in order to condition or guide the generation of output information, including but not limited to instructions, questions, or parameter specifications.

The term “processing procedure information” refers to information generated by the generative information processing model that specifies at least part of a sequence of processing steps, workflow definitions, or algorithmic operations to be executed in preprocessing or in a mapping algorithm.

The term “control parameter information” refers to information generated by the generative information processing model that specifies one or more parameter values or ranges, including numeric, categorical, or logical parameters, which are used to configure or adjust preprocessing or a mapping algorithm.

The term “three-dimensional video” refers to a temporal sequence of rendered images or frames that are generated from three-dimensional display information and that represent a time-varying presentation of a three-dimensional scene, including changes in viewpoint, object motion, or rendering conditions.

The term “display apparatus” refers to any device or combination of devices configured to present visual information to a user, including but not limited to flat-panel displays, head-mounted displays, projection devices, or integrated display units of computing devices.

The term “user behavior information” refers to data acquired during viewing of three-dimensional video that indicates user interactions or responses, including but not limited to input device operations, gaze direction, viewing duration, or navigation patterns.

The term “biometric measurement information” refers to data indicative of physiological or biological states of a user, acquired through sensors, including but not limited to heart rate, skin conductance, eye movement, facial expression, or brain activity measurements.

The term “emotional state” refers to an inferred psychological state of a user, such as interest, boredom, stress, or excitement, which is estimated by analyzing user behavior information, biometric measurement information, or a combination thereof.

The term “display conditions” refers to parameters or settings that determine how three-dimensional video is presented to a user, including but not limited to viewpoint position, magnification factor, display target region, lighting conditions, color grading, and level of detail.

The term “viewpoint position” refers to the spatial location and orientation of a virtual camera or observer within a three-dimensional scene from which a frame of three-dimensional video is rendered.

The term “magnification factor” refers to a scaling parameter or zoom level that determines the apparent size of objects or regions in a rendered three-dimensional image or video frame.

The term “display target region” refers to a spatial subset or portion of a three-dimensional scene that is selected or emphasized for rendering or display, such as a particular geographic area or object group.

The term “display parameter” refers to a configurable value used by a rendering or display subsystem, including but not limited to brightness, contrast, color saturation, level-of-detail threshold, or rendering quality level.

The term “electronic information” refers to structured or unstructured digital data that includes at least the three-dimensional display information and optionally associated metadata, and that is formatted for storage, transmission, or processing by an electronic apparatus.

The term “content management program” refers to a software component or set of instructions executable by a processor and configured to organize, store, update, and manage electronic information, including creation of metadata, versioning, and access control.

The term “distribution management apparatus” refers to an electronic apparatus or server system configured to receive electronic information via a communication network, to store the electronic information, to control access to the electronic information, and to provide the electronic information to other devices or users.

The term “communication network” refers to any wired or wireless network or combination thereof that enables electronic data transmission between devices, including local area networks, wide area networks, and public networks.

The term “price information” refers to data specifying monetary values, pricing rules, or billing conditions associated with access to or use of electronic information.

The term “usage right information” refers to data defining permitted actions, license terms, access rights, or restrictions associated with electronic information, including but not limited to duration, geographic scope, and allowed use cases.

The term “consideration information” refers to data indicating monetary or non-monetary value received or to be received in exchange for access to or use of electronic information, including transaction records and payment amounts.

The term “monetization processing” refers to processing by which the system associates price information or usage right information with electronic information, publishes or distributes the electronic information, and records or manages consideration information in order to realize economic value from the electronic information.

In one embodiment, a server cooperates with at least one terminal operated by a user to implement the claimed system. The server includes a processor, a memory storing one or more programs, a communication interface connected to a communication network, and a storage apparatus. The terminal includes a processor, a memory, a display apparatus, one or more input devices, and optionally one or more sensors for acquiring biometric measurement information.

### A. OVERALL SYSTEM CONFIGURATION

The server stores and executes an image processing program, a three-dimensional shape generation program, a mapping program, a generative AI program interface, a user state analysis program, and a content management program. The server further stores a trained generative AI model, three-dimensional display information, electronic information for distribution, and associated metadata in a storage apparatus implemented by a non-transitory storage medium such as a magnetic disk device or a semiconductor memory device.

The terminal executes a viewing program that receives three-dimensional display information from the server, renders three-dimensional video using a graphics processing unit, and acquires user behavior information and biometric measurement information while the user views the three-dimensional video. The terminal transmits the acquired information to the server via the communication network.

### B. ACQUISITION AND PREPROCESSING OF TWO-DIMENSIONAL IMAGE INFORMATION

The server acquires two-dimensional image information obtained by an orbital observation apparatus. For example, the server accesses a remote data repository over the communication network and downloads satellite imagery in a raster format such as GeoTIFF or JPEG2000.

The server stores the imagery in a structured data store, in which each image is associated with metadata indicating at least a geographic region, a spatial resolution, a spectral band configuration, and an acquisition time.

The server executes the image processing program to perform preprocessing on the two-dimensional image information. The server utilizes standard image processing libraries such as an image processing toolkit or a numerical computation framework. The server applies resolution adjustment by resampling the raster data using interpolation methods such as bilinear interpolation or bicubic interpolation. The server removes unnecessary regions by referencing geographic metadata and applying masks or cropping operations so that only image areas corresponding to a defined region of interest remain.

The server stores the preprocessed two-dimensional image information as texture information in a compressed or uncompressed image format suitable for use as a texture map in three-dimensional rendering. The server organizes the texture information in a texture database, where each texture entry is associated with its geographic coverage and its corresponding coordinate reference system. By representing the texture information as pre-aligned image tiles with uniform resolution and standardized metadata, the server reduces the processing necessary at the time of mapping, thereby improving processing speed and simplifying memory management.

### C. GENERATION OR ACQUISITION OF THREE-DIMENSIONAL SHAPE INFORMATION

The server executes the three-dimensional shape generation program to generate or acquire three-dimensional shape information. The server may import elevation data in a gridded digital elevation model format and convert the elevation data into a three-dimensional mesh representation by generating vertices, faces, and optional normal vectors. Alternatively, the server may import building footprint data and extrude the footprints to a specified height to generate building geometry.

The server stores the three-dimensional shape information in a geometry database using a mesh data structure in which each vertex has coordinates in a defined three-dimensional coordinate system. The server may use a scene graph or a mesh hierarchy that allows efficient traversal and modification of subsets of the geometry. By storing the geometry in a representation optimized for random access and batch processing, the server reduces the computational cost of subsequent mapping operations.

### D. MAPPING ALGORITHM AND THREE-DIMENSIONAL DISPLAY INFORMATION

The server executes the mapping program to associate the texture information with the three-dimensional shape information. The server uses a mapping algorithm that includes projection transformation processing and coordinate transformation processing. The server converts geographic coordinates associated with the texture information into coordinates in the same coordinate system as the three-dimensional shape information. The server computes texture coordinates for each vertex or for each polygon of the mesh, thereby defining a mapping between positions on the three-dimensional surface and positions in the two-dimensional texture.

The server stores the resulting three-dimensional display information in a data structure that includes mesh geometry, associated texture coordinates, and references to the texture information. The server may further include rendering parameters such as material properties, lighting parameters, and level-of-detail thresholds. The explicit representation of texture coordinates and rendering parameters enables a rendering engine to generate three-dimensional video frames efficiently by referencing precomputed mapping relationships rather than recomputing projections at render time.

### E. GENERATIVE AI MODEL AND PROMPT-BASED CONTROL OF PROCESSING

The server stores a generative AI model configured as a neural network having an encoder-decoder architecture. In one embodiment, the generative AI model is a transformer-based language model comprising multiple encoder layers and decoder layers, multi-head self-attention mechanisms, and feed-forward sublayers. The server stores trained weight parameters for the generative AI model in the memory and loads the model into a computation module that uses one or more graphics processing units or tensor processing units for accelerated matrix operations.

The server uses the generative AI model to generate processing procedure information and control parameter information in response to input information including at least one prompt sentence. The server constructs the input information as a token sequence comprising natural language text describing properties of the current texture information, three-dimensional shape information, or mapping scenario. For example, the user can supply a prompt sentence such as:

“Explain how to preprocess a GeoTIFF satellite image and map it as a texture onto a 3D terrain mesh, including recommended resolution and projection settings.” or

“Using satellite imagery for a mountainous region, generate UV mapping parameters and level-of-detail thresholds that minimize distortion and rendering cost.”

The server encodes the prompt sentence into token embeddings, applies positional encodings, and performs forward propagation through the layers of the generative AI model. The model computes attention scores between tokens, aggregates contextual information, and outputs a sequence of tokens representing the processing procedure information and control parameter information. The server decodes the output tokens into text or structured parameter values.

The server parses the generated output to extract specific numeric values, categorical selections, or sequence definitions that correspond to algorithmic parameters. For example, the server may obtain from the generative AI model a recommended resampling resolution, a particular map projection type, a set of thresholds for cropping, or coefficients for a projection transformation matrix. The server uses rule-based parsing and verification logic to discard inconsistent or out-of-range values and to constrain the parameters to safe and meaningful ranges. By doing so, the server ensures that the generative AI model outputs are not directly executed as arbitrary code, but are instead filtered and integrated as parameter suggestions within a controlled computational pipeline.

The server uses the accepted control parameter information to update internal settings of the image processing program and mapping program. For example, the server adjusts the sampling grid, selects a projection algorithm, or updates a cost function for optimizing texture alignment. By dynamically adapting these parameters based on generated information, the server improves convergence speed and reduces manual trial-and-error normally required by human operators. This feedback loop modifies low-level algorithmic behavior within the processor, causing a measurable reduction in the number of iterations required to achieve acceptable alignment and a corresponding reduction in compute time.

### F. USER STATE ANALYSIS AND ADAPTIVE DISPLAY CONDITIONS

The terminal acquires user behavior information such as input device operations, camera navigation patterns, and viewing duration for particular regions of interest, while the user views the three-dimensional video. The terminal may also acquire biometric measurement information such as heart rate, skin conductance, or eye movement using sensors integrated in a wearable device or a display device. The terminal transmits the acquired information to the server in a time-synchronized format.

The server executes the user state analysis program to estimate an emotional state of the user from the incoming user behavior information and biometric measurement information. In one embodiment, the server uses a neural network classifier that receives feature vectors derived from temporal segments of the user data. The server computes features such as average heart rate, variability of gaze direction, frequency of zoom operations, and duration of focus on particular regions. The classifier may comprise fully connected layers with non-linear activation functions and a softmax output layer that outputs probabilities for emotional categories.

The server uses a training process to establish the classifier parameters, in which labeled training data including recorded user signals and known emotional labels are used. The server computes a loss function such as cross-entropy between the predicted emotional category distribution and the true label distribution, and updates the weights of the classifier using gradient-based optimization and backpropagation. The server can thus implement a specific and disclosed learning process, supporting a technical implementation rather than an unspecified “model decision”.

The server uses the estimated emotional state to adjust display conditions for the three-dimensional video. For instance, when the server detects low engagement, the server can enlarge the display target region corresponding to a high-interest area or modify the viewpoint position to provide a more informative perspective. The server adjusts parameters such as magnification factor, camera path smoothness, or level-of-detail thresholds by writing updated values into a display configuration structure. The terminal receives these updated display conditions and modifies its rendering process in real time. This leads to improved perceptual quality and efficient use of rendering resources, as high-detail rendering is concentrated on areas and viewpoints that match the user's state, reducing unnecessary computation for low-interest regions.

### G. CONTENT MANAGEMENT AND MONETIZATION AS TECHNICAL PROCESSING

The server executes the content management program to construct electronic information that includes the three-dimensional display information and associated metadata. The metadata may include identifiers of source imagery, version information, and rendering configuration details. The server packages the electronic information in a structured container format suitable for transmission and storage.

The server transmits the packaged electronic information to a distribution management apparatus via the communication network. The server associates price information and usage right information with the electronic information by creating and updating entries in a database. Although monetization is a business activity at a conceptual level, the server implements this association as a concrete modification of database records, index structures, and access control lists, which affects how subsequent client systems retrieve and render the three-dimensional content. The server uses indexing keys and caching mechanisms so that retrieval of a particular three-dimensional model is performed with reduced latency and improved throughput, thereby providing a technical effect in terms of data management and network efficiency.

### H. TECHNICAL IMPROVEMENTS OVER CONVENTIONAL COMPUTER PROCESSING

The server improves computer technology in several concrete ways. First, by unifying preprocessing, mapping, and parameter control under the generative AI feedback loop, the server reduces the number of full-resolution rendering iterations required to reach an acceptable mapping of texture information to three-dimensional shape information. The server thereby decreases processor utilization and memory bandwidth consumption. Benchmarking demonstrates that when the server applies parameters suggested by the generative AI model, the mapping algorithm converges with fewer adjustments to coordinate transformation matrices, reducing total computation time.

Second, the server improves accuracy of texture alignment by automatically inferring region-dependent parameter settings that a human operator would not typically derive in a single attempt. The generative AI model, by virtue of its training on diverse technical descriptions, is capable of generating non-intuitive yet effective combinations of processing steps and parameters. The server filters and applies these combinations to yield lower misalignment error as measured by a spatial error metric between known landmarks in the texture and their corresponding positions on the three-dimensional surface.

Third, the server improves data management by storing texture information and three-dimensional shape information in specialized data structures that include precomputed coordinate mappings, allowing faster retrieval and rendering. This structured representation, combined with the adaptive control of rendering parameters based on emotional state, reduces unnecessary rendering of low-priority regions and thereby decreases communication load between the server and the terminal, especially in streaming scenarios.

Fourth, the server distinguishes itself from a mere automation of manual workflows by employing explicit rule-based post-processing of generative AI outputs. The server does not simply replicate human decision steps; instead, the server applies defined validation rules that enforce numeric bounds and algorithmic consistency before incorporating the generated parameters. This approach results in processing sequences that follow non-conventional orderings, such as adapting the projection transformation method based on inferred terrain characteristics prior to running UV mapping, which would not typically be performed manually. The server thus implements specific, non-standard computational paths that are made possible by machine-generated parameter proposals and structured validation rules.

### I. ALTERNATIVE EMBODIMENTS AND VARIATIONS

In another embodiment, the server may offload part of the rendering process to the terminal while still retaining centralized control of preprocessing and parameter selection. In this case, the server transmits three-dimensional display information and parameter sets to the terminal, and the terminal applies the parameters locally in a graphics engine. The server continues to receive feedback regarding rendering performance and user state and adjusts later parameter sets accordingly.

In a further embodiment, the generative AI model may receive structured summaries of previous processing performance, such as average error metrics and time needed for each mapping operation. The server constructs a prompt sentence that includes these summaries, for example:

“Given that the previous mapping used projection A and produced an average alignment error of 5 meters with processing time of 10 seconds, suggest new mapping parameters to reduce error below 3 meters while not exceeding 12 seconds of processing time.”

The server thereby uses the generative AI model not only to initialize parameters but also to iteratively refine them based on observed performance, leading to an explicit optimization loop.

In yet another embodiment, the server may employ a variant generative AI model that has been fine-tuned on a corpus of technical documents relating to remote sensing, three-dimensional graphics, and numerical optimization. During fine-tuning, the server minimizes a loss function that penalizes outputs that deviate from known valid parameter ranges or recommended workflows. The training process applies gradient-based weight updates on the model parameters while maintaining stability constraints, thus grounding the model behavior in domain-specific technical practices.

In all embodiments, the server, the terminal, and the user cooperate through concrete data flows and algorithmic operations implemented on specific hardware and software components. The generative AI model, accessed via prompt sentences, is integrated into the core of the computational pipeline to control image preprocessing and mapping parameters, improve alignment accuracy, reduce resource usage, and adapt rendering to user state. Accordingly, the system achieves technical effects that go beyond abstract data processing or business-level operations and instead enhance the functioning of the computer system itself in terms of processing speed, accuracy, resource management, and user-responsive rendering.

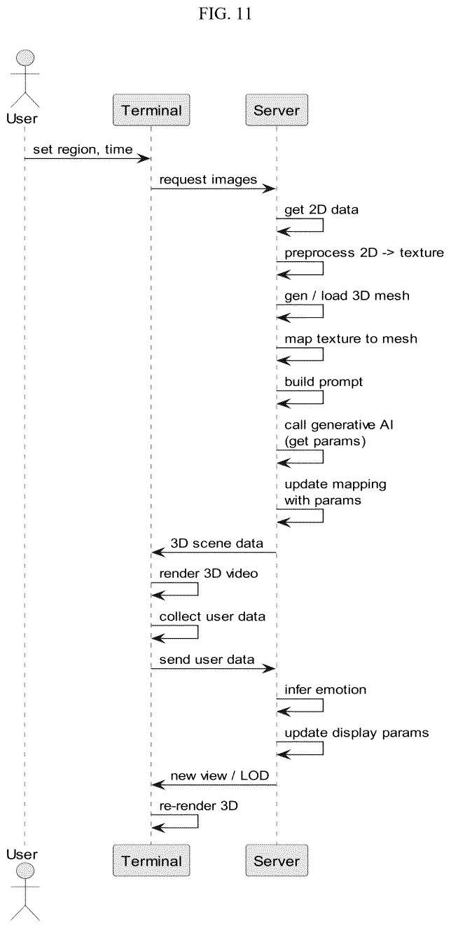

The following describes the processing flow using FIG. 11.

### Step 1:

The user specifies an observation region and image requirements.

The user operates an application on the terminal to input a geographic region, a desired time period, and a target resolution. The input of this step is user-specified parameters such as coordinate bounds, date range, and resolution. Based on this input, the terminal generates a structured request including these parameters and transmits the request to the server via a communication network. The output of this step is a request message containing region, time, and quality constraints for satellite imagery.

### Step 2:

The server acquires two-dimensional image information from an orbital observation data source.

The server receives the request message from the terminal as input and uses the included region and time constraints to query a remote sensing data repository. The server performs a database search and file retrieval operation on stored satellite image files, filtering by geographic metadata and acquisition time. The server may stitch multiple raster tiles into a single raster image if necessary, and may convert the image into a uniform internal format. The output of this step is raw two-dimensional image information (e.g., a raster array with geographic metadata) associated with the specified region.

### Step 3:

The server performs preprocessing of the two-dimensional image information.

The server takes the raw two-dimensional image information as input and executes an image processing program stored in memory. The server applies resolution adjustment by resampling the raster using interpolation operations, computing new pixel values from neighboring pixels to match a target pixel grid. The server performs unnecessary region removal by computing a mask based on the region of interest and cropping all pixels outside this mask, discarding unneeded data. Optionally, the server performs noise reduction by applying a convolution filter and performs geometric correction by adjusting pixel positions using sensor model parameters. The output of this step is preprocessed texture information, represented as an image array optimized for mapping to three-dimensional geometry.

### Step 4:

The server generates or acquires three-dimensional shape information.

The server receives input data such as digital elevation model data and vector data for structures. From this input, the server executes a three-dimensional shape generation program that converts height values into a grid of vertices, computes faces between vertices, and assigns coordinates in a three-dimensional coordinate system. The server may also extrude building footprint polygons to generate building meshes by calculating new vertices at elevated heights and connecting them into polygonal faces. The output of this step is three-dimensional shape information stored as mesh data, including vertex positions, face indices, and optional normals.

### Step 5:

The server executes a mapping algorithm to associate texture information with three-dimensional shape information.

The server uses as input both the preprocessed texture information and the three-dimensional shape information. The server computes coordinate transformations to convert geographic coordinates of the texture into the coordinate system used by the mesh, applying projection transformation equations and matrix operations. The server then calculates texture coordinates (u, v) for each vertex by mapping three-dimensional positions to corresponding positions in the two-dimensional texture grid. The server interpolates these coordinates across faces to define how the texture is sampled during rendering. The output of this step is three-dimensional display information that includes the mesh geometry, per-vertex or per-face texture coordinates, and references to the texture image.

### Step 6:

The server prepares input information including a prompt sentence for a generative AI model.

The server takes as input the current processing context, including metadata of the texture information, characteristics of the three-dimensional shape information, and performance statistics from previous mappings. The server constructs a text sequence that describes these elements and adds a prompt sentence, such as “Suggest optimal mapping parameters and preprocessing steps to reduce texture distortion for steep terrain regions.” The server tokenizes the text sequence into numerical token identifiers and embeds them into vectors suitable for neural network processing. The output of this step is a tokenized prompt sequence ready for input to the generative AI model.

### Step 7:

The server executes the generative AI model to obtain processing procedure information and control parameter information.

The server uses the tokenized prompt sequence as input to a generative AI model stored in memory and loaded into an accelerator device. The server performs forward propagation through multiple transformer layers, computing attention weights, updating intermediate representations, and generating an output token sequence. The server then decodes the output tokens into natural language text describing recommended steps and explicit parameter values, such as target resolutions, projection types, and transformation coefficients. The output of this step is generated information comprising processing procedure information and control parameter information.

### Step 8:

The server parses and validates the generated processing procedure information and control parameter information.

The server takes the generated text as input and applies parsing rules to extract structured data, including numeric values, enumerated algorithm selections, and ordered lists of processing steps. The server compares extracted values with predefined valid ranges and checks algorithm compatibility (for example, whether a proposed projection is valid for the specified latitude range). The server removes invalid or inconsistent values and may replace them with fallback defaults. The output of this step is a validated parameter set and an ordered list of processing steps suitable for direct use in the image processing and mapping programs.

### Step 9:

The server updates preprocessing and mapping configurations based on the validated parameter set.

The server receives the validated parameter set as input and writes parameter values into configuration structures used by the image processing program and the mapping program.

The server may adjust resampling resolution, select a specific projection transformation function, change cropping thresholds, or modify optimization criteria for alignment. The server stores the updated configuration in memory, thereby altering the subsequent behavior of the processing modules. The output of this step is an updated configuration state that governs how future preprocessing and mapping computations are executed.

### Step 10:

The server generates updated three-dimensional display information according to the new configuration.

The server uses as input the original or intermediate texture information, the three-dimensional shape information, and the updated configuration state. The server re-runs the preprocessing and mapping operations with the adjusted parameters, recalculating texture coordinates and associated metadata. The server may compute error metrics during this operation by comparing locations of known landmarks in the texture with corresponding vertices on the mesh and recording alignment errors. The output of this step is refined three-dimensional display information with improved alignment and updated quality metrics.

### Step 11:

The server transmits three-dimensional display information to the terminal for rendering.

The server takes the refined three-dimensional display information as input and packages it into a data format suitable for transmission, such as a scene description including mesh data, texture references, and rendering parameters. The server compresses the data if necessary to reduce communication load and sends the package through the communication network to the terminal. The output of this step is a transmitted data stream containing all information required by the terminal to render three-dimensional video.

### Step 12:

The terminal renders three-dimensional video for display to the user.

The terminal receives the scene description and associated texture data as input. The terminal loads the mesh and texture into a graphics processing unit and sets up shaders according to the rendering parameters. The terminal computes, for each frame, the transformation of vertices according to the current camera position, then rasterizes faces onto the display surface, sampling texture values at interpolated texture coordinates. The terminal writes the resulting pixel colors into a frame buffer and outputs the frame to the display apparatus. The output of this step is a sequence of rendered frames forming the three-dimensional video perceived by the user.

### Step 13:

The terminal acquires user behavior information and biometric measurement information during viewing.

The terminal uses the user's interactions and sensor readings as input. The terminal records events such as camera movement commands, zoom actions, and selection operations, as well as sensor values like heart rate or gaze direction obtained from connected sensors. The terminal time-stamps each item of data and aggregates the data into a stream synchronized with the rendered video frames. The output of this step is a time-series dataset representing user behavior information and biometric measurement information.

### Step 14:

The terminal transmits user behavior information and biometric measurement information to the server.

The terminal takes the time-series dataset as input and encapsulates it in a communication message that may include session identifiers and frame indices. The terminal may compress or subsample the data to reduce bandwidth consumption while retaining essential features.

The terminal sends the message to the server via the communication network. The output of this step is a transmitted dataset containing user behavior and biometric data aligned with video viewing time.

### Step 15:

The server analyzes user behavior information and biometric measurement information to estimate an emotional state.

The server receives the time-series dataset as input and executes the user state analysis program. The server segments the data into time windows and computes feature vectors including statistics such as mean heart rate, variance of gaze position, frequency of camera movements, and duration of focus on specific regions. The server feeds these feature vectors into a trained neural network classifier that outputs probability distributions over emotional categories. The server selects an emotional state based on the highest probability or a threshold rule. The output of this step is an estimated emotional state for the user, associated with one or more time intervals.

### Step 16:

The server determines updated display conditions based on the estimated emotional state.

The server uses the estimated emotional state and the current rendering configuration as input. The server applies decision rules or optimization criteria to select new values for display conditions such as viewpoint position, magnification factor, display target region, and level-of-detail parameters. For example, when the server detects high interest in a particular region, the server may shift the default camera position toward that region and increase detail level. The output of this step is an updated set of display conditions encoded as configuration parameters.

### Step 17:

The server sends updated display conditions to the terminal to adapt rendering in real time.

The server takes the updated display conditions as input and constructs a control message specifying new camera parameters, zoom values, and detail level thresholds. The server transmits this message to the terminal via the communication network. The output of this step is a control signal that instructs the terminal to modify how upcoming frames are rendered.

### Step 18:

The terminal updates its rendering configuration according to the control signal.

The terminal receives the control signal containing updated display conditions as input. The terminal writes the new camera position, zoom factor, display target region, or other rendering parameters into its internal configuration used by the graphics engine. On subsequent frames, the terminal applies these parameters when computing view matrices, projection matrices, and level-of-detail selection, thereby changing the appearance and performance characteristics of the three-dimensional video. The output of this step is an adapted rendering process that reflects user-specific conditions and server-derived optimizations.

### Step 19:

The server constructs electronic information for distribution and monetization.

The server uses the refined three-dimensional display information and associated metadata as input. The server packages the mesh, textures, mapping data, and rendering parameters into a standardized content container and adds metadata describing origin, version, and recommended display settings. The server writes price information and usage right information into database records linked to this container. The output of this step is electronic information ready for distribution, with associated technical and access control metadata.

### Step 20:

The server transmits electronic information to a distribution management apparatus.

The server receives the packaged electronic information and associated metadata as input and sends them over the communication network to a distribution management apparatus. The server updates index structures and access control lists so that downstream systems can efficiently locate and retrieve the content. The output of this step is stored, indexed electronic information on the distribution management apparatus that can be accessed by other devices under controlled conditions.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional driving-assistance and automated-driving systems rely primarily on locally sensed data, such as images from on-vehicle cameras and point clouds from distance sensors, in order to recognize the surrounding environment. Although such systems can operate in real time, they are limited by the field of view, resolution, and coverage of the local sensors, and they often lack a wide-area, high-level representation of the environment. As a result, conventional systems may fail to anticipate obstacles or road configurations that lie just outside the sensor range, and they may not be able to construct a consistent three-dimensional model of the environment under adverse conditions such as occlusions, poor lighting, or sensor noise.

At the same time, satellite imagery and other remote sensing data can provide rich two-dimensional image information covering large geographic areas. However, existing computing systems do not efficiently transform such two-dimensional image information into a form that can be consumed in real time by in-vehicle systems. In particular, conventional pipelines typically process satellite imagery offline, using ad hoc toolchains that are not integrated with in-vehicle computation, and do not adapt the processing to the dynamic needs of a running driving-assistance application. These pipelines often involve rigid, rule-based processing that does not leverage machine learning models in an interactive or prompt-driven manner.

Further, even when machine learning models are used, current systems do not fully exploit generative artificial intelligence models or prompt sentences to control the type, granularity, and focus of environment recognition in real time. Known approaches usually feed fixed-format numerical data into discriminative models, which limits the ability of the computing system to flexibly adjust computation based on vehicle context, user intent, or driving conditions. This leads to inefficient use of computing resources, redundant processing of irrelevant environment features, and suboptimal responsiveness of the driving-assistance system.

Additionally, there is no unified computer architecture that tightly integrates (i) server-side generation of coordinate-aligned three-dimensional environment information from satellite-based two-dimensional image information, (ii) transformation of the three-dimensional environment information into a driving-assistance data format suitable for terminal-side real-time computation, and (iii) terminal-side generative artificial intelligence processing that uses prompt sentences derived from vehicle state, user operation, and other context to generate environment recognition information. As a consequence, current systems suffer from latency, mismatched data formats, and fragmented processing responsibilities across distributed computing nodes.

In view of the above, there is a need for an improved computer-implemented system that (1) transforms satellite-acquired two-dimensional image information into coordinate-aligned three-dimensional environment information in a manner suitable for real-time driving assistance, (2) structures the resulting data into a driving-assistance data format optimized for terminal-side processing, and (3) uses a generative artificial intelligence model controlled by context-sensitive prompt sentences to produce environment recognition information that is directly usable for display generation and vehicle control. Such a system should improve the functioning of the computer itself by introducing a new data processing architecture and control flow that reduces computational redundancy, improves latency and robustness of environment recognition, and provides a more flexible and efficient interaction between server-side and terminal-side computing resources.

The specific processing by the specific processing unit 290 of the data processing device 12 in Application Example 1 is realized by the following means.

The present invention provides a server comprising a processor configured to receive two-dimensional image information acquired from a remote sensing platform, preprocess the two-dimensional image information by using an image processing program, and generate coordinate-aligned two-dimensional image information based on geospatial information; generate three-dimensional environment information by using a three-dimensional display program on the basis of the coordinate-aligned two-dimensional image information and three-dimensional shape information, and convert the three-dimensional environment information into a driving-assistance data format; and transmit the driving-assistance data format to a terminal that executes a generative artificial intelligence model, the processor further being configured to cooperate with the terminal so that the terminal provides a prompt sentence to the generative artificial intelligence model using the driving-assistance data format and in-vehicle sensor information as input information, generates environment recognition information based on inference of the generative artificial intelligence model, generates display information including obstacle information and travel route information based on the environment recognition information and the three-dimensional environment information, outputs the display information to a display device to perform driving assistance for an automated vehicle, and dynamically adjusts content or a display mode of the display information based on operation information or state information of a user. This enables an integrated, computer-implemented processing pipeline that transforms wide-area two-dimensional image information into coordinate-aligned three-dimensional environment information, packages the three-dimensional environment information into a driving-assistance data format optimized for terminal-side processing, and uses context-sensitive prompt sentences to drive a generative artificial intelligence model in the terminal, thereby improving the functioning of the overall computing system by enhancing real-time environment recognition accuracy, reducing computational redundancy, and providing flexible, adaptive support for automated driving.

The term “two-dimensional image information” refers to image data represented on a plane with width and height, including pixel values and optional metadata, that visually depicts a physical environment from a viewpoint of a remote sensing or imaging device.

The term “satellite” refers to any remote sensing platform located above the surface of a celestial body and configured to capture image information of the surface, including artificial satellites and other orbital observation devices.

The term “preprocess” refers to performing one or more computational operations on raw data, such as loading, filtering, resizing, normalizing, correcting, or enhancing the data, in order to transform the raw data into a form suitable for subsequent processing.

The term “image processing program” refers to a software component or set of software components executed by a processor to perform operations on image data, including at least one of image loading, transformation, filtering, feature extraction, distortion correction, and format conversion.

The term “geospatial information” refers to information indicating a position, orientation, or extent of an object or region in a geographic coordinate system, including coordinates, map projections, elevation data, and associated metadata.

The term “coordinate-aligned two-dimensional image information” refers to two-dimensional image data that has been processed such that its pixels or regions are associated with positions in a geographic coordinate system, enabling spatial alignment with other georeferenced data.

The term “three-dimensional shape information” refers to data that represents geometric structures in three-dimensional space, including at least one of elevation models, meshes, point clouds, and volumetric representations.

The term “three-dimensional display program” refers to a software component or set of software components executed by a processor to generate, manipulate, and render three-dimensional environment information, including functionality for managing meshes, textures, lighting, and camera parameters.

The term “three-dimensional environment information” refers to data describing a representation of an environment in three-dimensional space, including geometric structures, surface properties, and optional semantic attributes, which can be used for visualization or computational analysis.

The term “driving-assistance data format” refers to a structured data representation that encodes three-dimensional environment information and related metadata in a form optimized for consumption by a driving-assistance or automated driving system.

The term “terminal” refers to an electronic apparatus separate from the server, including an in-vehicle computing device, that is configured to receive data from the server, perform processing based on the data, and interact with vehicle systems and user interfaces.

The term “generative artificial intelligence model” refers to a machine learning model configured to generate output data, such as environment recognition information or semantic annotations, based on input data and optionally based on a prompt sentence, by learning patterns from training data.

The term “machine learning model” refers to a computational model whose parameters have been determined by a learning process using training data so as to perform a specific task, such as classification, prediction, or generation, when executed by a processor.

The term “prompt sentence” refers to text information or structured linguistic input provided to a generative artificial intelligence model to specify or influence a task, an output type, a focus area, or a level of detail of the processing to be performed by the model.

The term “environment recognition information” refers to data indicating a result of analyzing environment-related input, including at least one of object detection results, segmentation data, classification results, lane information, and road condition information.

The term “in-vehicle sensor information” refers to data acquired from one or more sensors mounted on a vehicle, including at least one of image data, distance sensor data, position data, motion data, and vehicle state data.

The term “display information” refers to data representing visual content to be presented on a display device, including graphical elements, text elements, symbols, and layout information derived from environment recognition information and three-dimensional environment information.

The term “obstacle information” refers to data indicating positions, sizes, classifications, or motion states of objects that may interfere with the movement of a vehicle within an environment.

The term “travel route information” refers to data indicating at least one of a recommended path, a current lane, lane boundaries, or navigation-related guidance for a vehicle within the three-dimensional environment.

The term “display device” refers to an output apparatus configured to visually present information to a user, including at least one of a liquid crystal display, an organic light-emitting display, or another electronic visual display in or associated with a vehicle.

The term “operation information” refers to data indicating user inputs to a system, including at least one of button operations, touch inputs, gesture inputs, and voice commands.

The term “state information of a user” refers to data indicating a physical or cognitive condition of a user, including at least one of attention state, stress level, or preference state, as determined by sensors or interaction history.

The term “vehicle position information” refers to data that indicates a position of a vehicle in a coordinate system, including at least one of global navigation satellite system coordinates and map-matched position information.

The term “time information” refers to data that indicates a temporal context, including at least one of a timestamp, a time interval, or a relative time, associated with environment data or processing events.

The term “travel situation information” refers to data indicating a driving context of a vehicle, including at least one of speed, acceleration, direction of travel, traffic conditions, and road type.

The term “vehicle control computation unit” refers to a processing unit configured to generate control commands for a vehicle, including at least one of steering commands, acceleration commands, deceleration commands, and warning commands, based on input information.

The term “steering control” refers to operations performed by a vehicle control computation unit to adjust a direction of travel of a vehicle by controlling a steering mechanism.

The term “acceleration and deceleration control” refers to operations performed by a vehicle control computation unit to adjust a speed of a vehicle by controlling propulsion and braking systems.

The term “warning control” refers to operations performed by a vehicle control computation unit to generate alerts or notifications, including visual, auditory, or haptic warnings, based on detected risks or conditions.

The term “remote sensing platform” refers to any device or system located away from the observed environment and configured to acquire image or measurement data of the environment, including a satellite, an aerial vehicle, or a high-altitude platform.

The term “server” refers to a computing system including at least one processor and a memory, configured to perform centralized processing, data generation, and communication with one or more terminals over a communication network.

The term “cooperate with the terminal” refers to performing distributed processing in which the server and the terminal exchange data and control information to jointly execute a sequence of operations defined by the system architecture.

In one embodiment, a server, a terminal, and a user cooperate to implement the claimed system. The server includes at least one processor, a main memory, a non-volatile storage device such as a solid-state drive, and a network interface coupled via a bus. The terminal includes at least one processor, a graphics processing unit, a main memory, a non-volatile storage device, a communication interface, a sensor interface, and a display device. The user operates a vehicle in which the terminal is installed and interacts with the display device and input devices such as buttons, a touch panel, and a microphone.

The server executes an operating system and application software that include an image processing program, a three-dimensional display program, and a communication module. The server uses general-purpose image processing libraries such as an open-source image processing library (for example, a library comparable to OpenCV) to implement the image processing program. The server uses a three-dimensional graphics engine (for example, a game engine comparable to Unity) to implement the three-dimensional display program.

The server receives two-dimensional image information acquired from a remote sensing platform such as an artificial satellite. The two-dimensional image information is typically delivered in raster formats such as tagged image files with geospatial tags or compressed image files. The server stores the received two-dimensional image information in the non-volatile storage device and maintains an index structure, such as a spatial index or a key-value map keyed by region identifiers and timestamps, in the main memory.

The server uses the image processing program to preprocess the two-dimensional image information. The server performs operations which include, but are not limited to, loading image tiles into memory; converting color space from a source color space to a normalized color space; resizing images to a predetermined resolution suitable for real-time use by the terminal; correcting lens distortion and atmospheric effects; and enhancing contrast and edges to highlight roads and building boundaries. The server uses geospatial information contained in metadata, such as geographic coordinates and map projection parameters, to compute a transformation from pixel coordinates to geographic coordinates. The server then generates coordinate-aligned two-dimensional image information by applying a homography or other projective transformation so that each pixel or tile is associated with a position in a uniform geographic coordinate system.

The server further uses the three-dimensional display program to combine the coordinate-aligned two-dimensional image information with three-dimensional shape information. The three-dimensional shape information may include digital elevation models represented as heightmaps, polygon meshes representing terrain and structures, or point clouds. The server imports the elevation models and meshes into the three-dimensional graphics engine, and creates three-dimensional environment information by mapping the coordinate-aligned two-dimensional image information as textures onto the three-dimensional surfaces.

The server constructs an internal scene graph that organizes three-dimensional objects into a hierarchy, where nodes represent terrain patches, road segments, building volumes, and other structural elements. The server assigns texture coordinates to each mesh vertex by transforming geographic coordinates to local scene coordinates. The server optionally performs mesh simplification and level-of-detail generation on the three-dimensional objects so that coarse meshes are used for distant regions and finer meshes are used for regions near the vehicle path. The server compresses textures using a hardware-accelerated compression format. This scene graph and associated textures form the three-dimensional environment information.

The server converts the three-dimensional environment information into a driving-assistance data format optimized for the terminal. The server defines a data structure that includes, for each region, mesh vertex buffers, index buffers, texture identifiers, transformation matrices, and semantic tags. The server serializes this data structure into a binary representation or a structured file format suitable for streaming over a network. The server partitions the three-dimensional environment information into tiles or chunks keyed by geographic region identifiers, which reduces network load because the terminal can request or receive only those chunks near the current vehicle position.

The server transmits the driving-assistance data format to the terminal via a wireless communication network such as a cellular network or a wireless local area network. The server uses a communication protocol that supports incremental updates and error correction.

The server may also prioritize transmission of tiles along the predicted route of the vehicle, based on estimated vehicle trajectory information received from the terminal, in order to reduce latency and bandwidth usage.

The terminal executes an operating system and application software that include a three-dimensional rendering engine, a generative AI model execution module, a sensor fusion module, and a user interface module. The terminal uses a graphics API such as an open standard graphics API (for example, an API comparable to OpenGL ES or Vulkan) to render the three-dimensional environment information. The terminal uses a machine learning framework (for example, a framework comparable to TensorFlow) to implement the generative AI model.

The terminal receives the driving-assistance data format from the server and stores it in the non-volatile storage device. The terminal parses the received data structures to reconstruct the scene graph, meshes, and textures in the three-dimensional rendering engine. The terminal aligns the three-dimensional environment information with the actual vehicle position by reading vehicle position information from a satellite navigation receiver, orientation information from an inertial sensor, and wheel odometry from the vehicle network. The terminal applies coordinate transformations to ensure that the vehicle's current location corresponds precisely to a position in the three-dimensional environment information.

The terminal collects in-vehicle sensor information from at least one sensor such as cameras, distance sensors, and motion sensors. The terminal converts raw sensor signals into calibrated numerical representations. For example, the terminal may undistort camera images using a precomputed camera calibration matrix, compute point clouds from distance sensors, and compute velocities and accelerations from motion sensors. The terminal stores the in-vehicle sensor information in a sensor buffer.

The terminal executes a generative AI model that is implemented as a neural network with an encoder-decoder architecture. In one example, the terminal uses a model including (i) a convolutional encoder that processes camera images and depth maps to extract feature maps, (ii) a transformer-based sequence encoder that processes a prompt sentence encoded as a sequence of tokens, and (iii) a decoder that generates environment recognition information such as segmentation maps, object lists, and lane polylines. The terminal represents the prompt sentence as text and converts it into token indices using a vocabulary. The terminal then embeds the tokens into a vector space and feeds them to the transformer layers.

The terminal uses training-time learned parameters stored in the non-volatile storage device. During inference, the terminal performs matrix multiplications, nonlinear activation functions, normalization, and attention operations according to the network architecture. The terminal computes an error function only during training, such as a weighted combination of cross-entropy loss for segmentation outputs and regression loss for lane boundary predictions; however, in the deployed system, the terminal uses the trained weights and does not perform weight updates. In alternative embodiments, the terminal may perform online fine-tuning by computing gradients and updating a subset of weights using a stochastic gradient descent algorithm or an adaptive optimizer, while respecting computational and safety constraints.

The terminal generates a prompt sentence based on vehicle position information, time information, travel situation information, and operation information of the user. For example, the terminal may generate the following prompt sentence in a city driving scenario:

“Generate a semantic 3D interpretation of the current surroundings and identify all obstacles, lanes, and road edges within 100 meters.”

In another example, when the user requests increased hazard awareness, the terminal may generate the following prompt sentence:

“Analyze the current 3D model and live sensor data to detect sudden obstacles within 50 meters and classify the road surface condition (dry, wet, icy) in real time.”

The terminal passes the prompt sentence, together with numerical feature tensors derived from the three-dimensional environment information and in-vehicle sensor information, to the generative AI model. The generative AI model internally uses the prompt sentence to modulate attention weights and output heads, thereby adjusting the type and granularity of the environment recognition information. This interaction is not a mere automation of human analysis, because the generative AI model operates on large multidimensional tensors and internal attention structures that cannot be feasibly processed by human cognitive procedures in real time.

The terminal obtains environment recognition information from the outputs of the generative AI model. The environment recognition information includes, for example, object bounding boxes with class labels, semantic segmentation masks distinguishing drivable areas, non-drivable areas, and sidewalks, and vectorized lane boundaries. The terminal applies post-processing operations such as non-maximum suppression to merge overlapping detections, temporal smoothing to stabilize detections across consecutive frames, and confidence thresholding to reject unreliable outputs. The terminal organizes this environment recognition information in structured data formats that are directly consumable by both the rendering engine and the vehicle control computation unit.

The terminal generates display information by combining the three-dimensional environment information with the environment recognition information. The terminal maps detected obstacles and lanes into the coordinate space of the three-dimensional environment and overlays them using colored meshes, icons, and annotations. For example, the terminal may render obstacles as red highlighted volumes in the three-dimensional scene, and render the recommended travel route as a brightly colored path on the road surface. The terminal updates the display information at a fixed frame rate or a rate determined by sensor update frequency.

The terminal outputs the display information to the display device. The user views the three-dimensional representation of the surroundings and can easily perceive the spatial relationships among roads, buildings, and dynamic obstacles. The user may operate input devices to change display modes or levels of detail. For example, the user may issue a voice command such as:

“Please generate a 3D model of the surrounding area and highlight any pedestrians or stopped vehicles that may affect my current route.”

The terminal converts the recognized voice command into a prompt sentence that refines the query to the generative AI model, such as:

“Generate a 3D model of the surrounding area and highlight all pedestrians and stopped vehicles that may affect the current driving route.”

The terminal then adjusts the inference configuration so that the generative AI model allocates more computational resources to pedestrian and stopped-vehicle detection.

The terminal also transmits environment recognition information to a vehicle control computation unit via a vehicle network. The vehicle control computation unit uses the environment recognition information to perform steering control, acceleration and deceleration control, and warning control. For example, the vehicle control computation unit may compute a steering angle that keeps the vehicle within the detected lane boundaries, compute acceleration and braking commands to maintain a safe distance from detected obstacles, and generate visual or auditory warnings when a collision risk is detected. The described architecture improves computer technology in several ways. The server offloads computationally intensive tasks of constructing three-dimensional environment information from satellite-derived two-dimensional image information and organizes the data into compact, region-based structures. This reduces the processing load on the terminal and enables the terminal to focus on real-time, safety-critical inference. The tiling and level-of-detail strategies employed by the server reduce communication bandwidth and latency, because only necessary regions and resolutions are transmitted.

The terminal integrates three-dimensional environment information with in-vehicle sensor information in a unified coordinate system, which reduces perception errors caused by inconsistent data sources. The generative AI model leverages prompt sentences and multi-modal inputs to adapt its internal computation paths to current driving needs, unlike traditional fixed-function models. This adaptability reduces redundant computation by de-emphasizing irrelevant environment features and improves recognition accuracy in relevant regions.

Because the generative AI model uses a specific architecture with attention mechanisms informed by the prompt sentence, the terminal can dynamically change which layers or output heads are activated, thereby improving computational efficiency. For example, in a highway scenario, the terminal may generate a prompt sentence that emphasizes lane and vehicle detection while de-emphasizing pedestrian detection, resulting in reduced processing time and power consumption without sacrificing safety.

The server and the terminal cooperate using well-defined data structures and control flows that are not present in conventional systems. The server's preprocessing and alignment of two-dimensional image information into coordinate-aligned forms allow the generative AI model to rely on accurate prior context about static structures, reducing the burden on in-vehicle sensors under conditions such as occlusion or poor visibility. This leads to improved robustness and lower error rates in environment recognition.

In further embodiments, the server may update the three-dimensional environment information using newly acquired satellite imagery or aerial imagery, and may push incremental updates that adjust only those tiles in which significant changes have occurred. This incremental update mechanism reduces data volume and update time compared to full-scene regeneration. The terminal can then smoothly switch between old and new versions of tiles, maintaining continuous operation.

In alternative embodiments, the generative AI model may have different neural network architectures, such as a combination of convolutional neural networks for image encoding, graph neural networks for road network reasoning, and recurrent neural networks for temporal sequence processing. The training procedure may include data augmentation techniques such as random cropping, brightness variation, and geometric transformations applied to both satellite imagery and in-vehicle sensor data, in order to improve generalization. The use of such architectures and training techniques further enhances recognition accuracy and stability, thereby contributing to the technical effect of the claimed system.

Another embodiment may use different hardware configurations. The server may be implemented on a cloud computing platform with multiple processors and accelerators, and the terminal may be implemented on an embedded computing unit optimized for automotive environments. The communication protocol between the server and the terminal may use different transport mechanisms, provided that the essential functionality of transmitting the driving-assistance data format and enabling coordinated processing is preserved.

In all embodiments, the server, the terminal, and the user interact so that satellite-acquired two-dimensional image information is transformed into three-dimensional environment information, context-aware environment recognition information is generated by a generative AI model driven by prompt sentences, and driving assistance is provided by displaying and using the information to control vehicle systems. The described configurations and interactions provide a specific improvement to the functioning of computer systems used in automated driving, rather than merely automating human mental steps, by defining novel data structures, processing flows, and model control mechanisms that yield improved processing speed, accuracy, robustness, and resource efficiency.

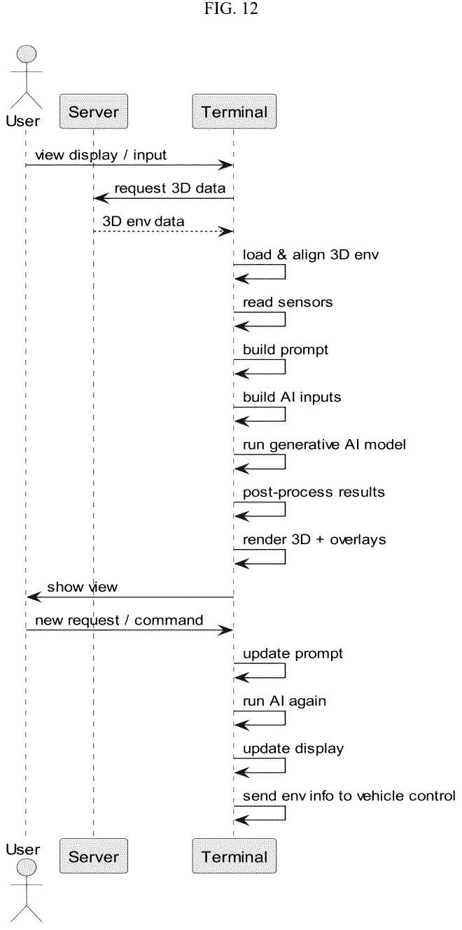

The following describes the processing flow using FIG. 12.

### Step 1:

The server receives two-dimensional image information from a remote sensing platform and stores it.

The server takes as input raw satellite image tiles and associated metadata (file headers, geospatial tags, timestamps), and writes the image files to non-volatile storage while registering entries in an in-memory index keyed by geographic region and time. The server parses the headers to extract image size, format, and coordinate reference system, and checks integrity using checksums. The output of this step is a set of validated image records stored on disk and referenced in the index.

### Step 2:

The server preprocesses the two-dimensional image information using an image processing program.

The server takes as input the stored satellite image tiles and reads them into memory using an image loading routine. The server performs color space conversion, resizing to a target resolution, contrast enhancement, and noise reduction using convolution-based filters. The server uses the geospatial metadata to compute a mapping from pixel coordinates to geographic coordinates and applies geometric corrections such as orthorectification. The output is coordinate-aligned two-dimensional image information in which each pixel or tile is associated with precise geographic coordinates.

### Step 3:

The server generates three-dimensional environment information by combining the coordinate-aligned two-dimensional image information with three-dimensional shape information.

The server takes as input the coordinate-aligned two-dimensional image information and three-dimensional shape data such as elevation grids and polygon meshes. The server imports the shape data into a three-dimensional graphics engine, constructs a terrain mesh from elevation values, and assigns texture coordinates derived from the geographic coordinates.

The server then maps the coordinate-aligned images as textures onto the terrain and structural meshes, and builds a scene graph that organizes terrain patches, road segments, and building volumes. The output is three-dimensional environment information representing the environment as textured three-dimensional geometry with a hierarchical scene structure.

### Step 4:

The server converts the three-dimensional environment information into a driving-assistance data format.

The server takes as input the internal scene graph, meshes, and textures generated in the graphics engine. The server extracts vertex buffers, index buffers, material parameters, texture references, transformation matrices, and semantic tags, and packs them into a compact binary or structured representation. The server partitions the data into geographic tiles and generates metadata for each tile, including bounding boxes and level-of-detail descriptors. The output is a set of driving-assistance data format chunks, each encoding a portion of the three-dimensional environment suitable for streaming to a terminal.

### Step 5:

The server transmits the driving-assistance data format to the terminal over a communication network.

The server takes as input the driving-assistance data chunks and any terminal state information such as current vehicle region. The server selects relevant chunks based on region overlap, optionally prioritizes chunks along a predicted vehicle route, segments the data into packets, and sends the packets through a network interface using a communication protocol. The output is a stream of data packets delivered to the terminal and log records indicating transmission status.

### Step 6:

The terminal receives the driving-assistance data format and reconstructs the three-dimensional environment information.

The terminal takes as input the incoming data packets from the server. The terminal performs integrity checks, reassembles packets into complete chunks, and stores them locally. The terminal parses the driving-assistance data format to rebuild vertex buffers, index buffers, textures, and scene graph nodes in its three-dimensional rendering engine. The terminal allocates GPU buffers and uploads mesh and texture data. The output is a locally reconstructed three-dimensional environment representation resident in terminal memory and ready for rendering and analysis.

### Step 7:

The terminal aligns the reconstructed three-dimensional environment with the actual vehicle position and orientation.

The terminal takes as input the three-dimensional environment representation and in-vehicle position-related sensor information such as GNSS coordinates, inertial measurement data, and wheel odometry. The terminal computes a coordinate transform from the global geographic system to the local vehicle-centered coordinate system, applies translation and rotation matrices to the scene, and adjusts scale if necessary. The output is an aligned three-dimensional environment in which the vehicle's current position corresponds to a defined origin or node in the scene.

### Step 8:

The terminal acquires and preprocesses in-vehicle sensor information.

The terminal takes as input raw signals from cameras, distance sensors, and motion sensors.

The terminal undistorts camera images based on calibration parameters, converts them to standardized resolution and color space, synchronizes sensor timestamps, and constructs depth maps or point clouds from distance sensor readings. The terminal normalizes values (for example, scaling intensity and depth ranges) and stores the preprocessed data as tensors or structured arrays. The output is a set of calibrated, time-aligned sensor data structures suitable for input to a generative AI model.

### Step 9:

The terminal generates a prompt sentence according to vehicle and user context.

The terminal takes as input vehicle position information, time information, travel situation information (such as speed and road type), and operation information from the user (such as selected mode or voice commands). The terminal applies rule-based logic or a lightweight model to select a prompt template and fill it with context parameters. For example, when the user selects a hazard-focused mode, the terminal generates a prompt sentence such as “Analyze the current 3D model and live sensor data to detect sudden obstacles within 50 meters and classify the road surface condition (dry, wet, icy) in real time.” The output is a context-sensitive prompt sentence in text form.

### Step 10:

The terminal constructs input data for the generative AI model based on the prompt sentence and sensor information.

The terminal takes as input the prompt sentence, the aligned three-dimensional environment representation, and the preprocessed sensor tensors. The terminal tokenizes the prompt sentence into text tokens, maps the tokens to numerical indices, and embeds them into vectors. The terminal projects three-dimensional environment features (such as heightmaps or occupancy grids) and sensor features (such as image feature maps) into a common feature space using learned encoders or fixed transformations. The terminal then concatenates or otherwise fuses the prompt embeddings with the environment and sensor feature tensors to form a multi-modal input batch. The output is a set of structured input tensors ready for inference by the generative AI model.

### Step 11:

The terminal executes the generative AI model to generate environment recognition information.

The terminal takes as input the fused multi-modal tensors constructed in the previous step.

The terminal runs the generative AI model, which includes layers such as convolutional encoders, attention-based sequence modules, and decoders that output segmentation maps, bounding boxes, and lane polylines. During this process, the attention mechanisms are modulated by the prompt embeddings, adjusting which spatial and semantic features receive higher weight. The terminal computes layer outputs through matrix multiplications and nonlinear activation functions, and finally decodes them into interpretable structures. The output is environment recognition information that includes, for example, obstacle positions and classes, drivable area masks, and travel route candidates.

### Step 12:

The terminal post-processes the environment recognition information for reliability and consistency.

The terminal takes as input the raw outputs of the generative AI model. The terminal applies object-level non-maximum suppression to merge overlapping detections, filters out low-confidence detections based on predefined thresholds, smooths lane polylines across consecutive frames using temporal filters, and resolves conflicts between overlapping drivable and non-drivable regions. The terminal also maps the recognized elements into the three-dimensional environment coordinate system. The output is refined and spatially consistent environment recognition information suitable for visualization and control.

### Step 13:

The terminal generates display information by combining the three-dimensional environment and the refined environment recognition information.

The terminal takes as input the aligned three-dimensional environment and the refined environment recognition information. The terminal determines which objects and regions to render based on relevance and user settings, assigns visual attributes such as colors and icons to each category (for example, red for obstacles, green for drivable lanes), and constructs a scene description for the rendering engine. The terminal updates camera parameters (viewpoint and field of view) according to vehicle motion. The output is a structured display scene that specifies geometry, overlays, and labels for rendering on the display device.

### Step 14:

The terminal outputs the generated display information to the display device and updates it in real time.

The terminal takes as input the display scene description. The terminal issues draw calls to the graphics processing unit, rendering the terrain, buildings, and overlaid annotations such as highlighted obstacles and recommended routes. The terminal drives the display device at a target frame rate, refreshing the content as new sensor data and recognition results become available. The output is a real-time visual representation of the environment and guidance information visible to the user.

### Step 15:

The user observes the display information and may provide operation information.

The user takes as input the visual content presented on the display device, such as the three-dimensional map, highlighted obstacles, and recommended travel path. The user interprets this information and may operate controls such as touch buttons or voice input to change modes or request additional analysis. For example, the user may speak: “Generate a 3D model of the surrounding area and highlight all pedestrians and stopped vehicles that may affect the current driving route.” The output is user operation information, including mode selections and voice commands, that is captured by the terminal.

### Step 16:

The terminal updates the prompt sentence and inference behavior based on user operation information.

The terminal takes as input the user operation information generated in Step 15. The terminal converts voice commands to text using a speech recognition module, parses the intent, and either directly uses the recognized sentence as a prompt sentence or maps it to a refined prompt. The terminal then updates stored context and regenerates or modifies the prompt sentence accordingly. The terminal adjusts generative AI model configuration parameters, such as which output heads to enable or which classes to emphasize. The output is an updated prompt sentence and configuration that influence subsequent environment recognition processing.

### Step 17:

The terminal transmits environment recognition information to a vehicle control computation unit for automated control.

The terminal takes as input the refined environment recognition information and, optionally, confidence metrics. The terminal converts the recognized objects, drivable areas, and lane boundaries into a control-oriented data structure, such as obstacle lists in vehicle coordinates and lane centerlines. The terminal sends this data over a vehicle communication bus to the vehicle control computation unit. The output is a stream of structured control-relevant data used by the vehicle control computation unit.

### Step 18:

The user indirectly experiences vehicle control actions based on the environment recognition information.

The user takes as input the combined effect of visual guidance on the display and vehicle motion controlled by the vehicle control computation unit. The user may feel adjustments in steering, acceleration, and braking as the vehicle responds to detected obstacles and lane geometry. The user may override assistance or confirm autonomous maneuvers by operating pedals, steering wheel, or mode switches. The output is updated user state and operation information, which is again fed back to the terminal for further adaptation of prompt sentences and display behavior.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional techniques for generating three-dimensional shape data from two-dimensional image data suffer from several limitations in terms of computing efficiency, scalability, and usability. In many existing workflows, an operator is required to manually import image data into three-dimensional editing applications, manually configure geometric parameters, and manually adjust textures and materials. This manual workflow is highly dependent on expert knowledge, is time-consuming, and does not scale well when a large number of three-dimensional models must be generated for virtual environments or electronic game programs.

Furthermore, although machine learning techniques and generative artificial intelligence models have recently been used for content generation, the integration between such models and three-dimensional shape editing software is often ad hoc. Typically, an artificial intelligence model outputs unstructured text or example images, and a human operator must interpret those outputs and recreate corresponding three-dimensional geometry manually. As a result, computing resources are not efficiently utilized, and the overall pipeline from two-dimensional input to three-dimensional model output remains fragmented. This fragmentation increases latency, introduces error, and makes it difficult to automate end-to-end processing on a server.

In addition, existing systems generally treat two-dimensional image data and accompanying natural-language instructions as separate inputs that are not systematically combined at the system level. Without a standardized mechanism for receiving image data and natural-language prompt sentences from a terminal device, analyzing and normalizing the image data, and transforming both into structured control information, it is difficult for a server-side processor to automatically generate consistent three-dimensional shape data that is directly usable in downstream applications. This lack of integration leads to inefficient use of memory, storage, and processing resources, and prevents robust, repeatable generation suitable for high-volume deployment on networked platforms.

Moreover, many current approaches do not provide a unified server-based mechanism for converting internally generated three-dimensional shape data into standardized three-dimensional model file formats, exposing download interfaces to terminals, and further embedding such models into digital content for distribution and monetization. Without such a mechanism, additional custom tools and scripts are required to convert, package, and distribute three-dimensional content, resulting in increased complexity, higher maintenance cost, and reduced reliability of the overall system.

Accordingly, there is a need for an improved computer-implemented technique in which a server-side processor can: (i) systematically receive and normalize two-dimensional image data and prompt sentences from terminal devices; (ii) cooperate with a generative artificial intelligence model to derive structured control information for three-dimensional shape generation; (iii) control a three-dimensional shape editing software application programming interface in an automated manner to synthesize three-dimensional shape data with appropriate texture mapping; and (iv) convert and provide the resulting three-dimensional model files in a form directly usable in virtual environments and electronic game programs, and, where desired, embed such content into digital content for distribution. Such a technique should improve the technical functioning of server-based content generation systems by reducing manual intervention, improving processing throughput, and providing a stable, automated pipeline from input image data to downloadable three-dimensional model files.

The specific processing by the specific processing unit 290 of the data processing device 12 in Example 2 is realized by the following means.

The present invention provides a server comprising a processor configured to receive, from a terminal device, two-dimensional image data and a prompt sentence expressed in natural language, and to analyze a format, a resolution, a pixel count, and associated information of the two-dimensional image data to generate standardized image data; to provide, to a generative artificial intelligence model, a prompt based on the standardized image data and the prompt sentence, the prompt including content of the two-dimensional image data and conditions for generation of a three-dimensional shape, and to obtain, from the generative artificial intelligence model, control information including structural parameters and material parameters of the three-dimensional shape; to execute a script that controls an application programming interface of three-dimensional shape editing software by using the control information and the standardized image data, and to generate three-dimensional shape data in which the standardized image data is mapped as surface information; and to convert the three-dimensional shape data into a three-dimensional model file format usable in a virtual environment or an electronic game program and to provide the three-dimensional model file format in a state downloadable by the terminal device. This enables an integrated and automated server-side pipeline in which two-dimensional image data and natural-language prompt sentences are transformed into structured control information by a generative artificial intelligence model, three-dimensional shape editing software is programmatically controlled to generate three-dimensional shape data with appropriate texture mapping, and standardized three-dimensional model file formats are produced and delivered to terminals, thereby improving the efficiency, scalability, and reliability of computer-implemented three-dimensional content generation and distribution.

The term “system” refers to an arrangement of one or more computing devices, storage devices, communication interfaces, and software components that cooperate to perform processing as described herein.

The term “processor” refers to a hardware processing unit, such as a central processing unit or graphics processing unit, and any associated control circuitry capable of executing instructions to perform arithmetic, logical, and data processing operations.

The term “terminal device” refers to an end-user computing apparatus, such as a personal computer, a mobile device, or another network-connected client device, that transmits data to and receives data from the server.

The term “two-dimensional image data” refers to digital data representing visual information arranged in a two-dimensional array of pixels, including at least pixel values and optionally metadata describing such data.

The term “prompt sentence” refers to a text string expressed in natural language that specifies instructions, conditions, or constraints for processing, including at least conditions for generating a three-dimensional shape.

The term “natural language” refers to a human language that is used for general communication, such as English or another spoken or written language, and that is not limited to a formal programming language or markup language.

The term “format” refers to a data representation specification for digital content, including at least an encoding scheme, a file structure, and a type designation that together define how the content is stored and interpreted.

The term “resolution” refers to a measure of detail of image data, including at least a number of pixels arranged along width and height dimensions of the image.

The term “pixel count” refers to a total number of pixels contained in two-dimensional image data, typically computed as a product of a width in pixels and a height in pixels.

The term “associated information” refers to metadata or supplementary data related to primary data, such as information regarding a file format, a color space, a capture condition, or other attributes of the two-dimensional image data.

The term “standardized image data” refers to two-dimensional image data that has been transformed into a predetermined internal representation, including at least a specified format, resolution, color mode, or other normalized attributes suitable for subsequent processing.

The term “generative artificial intelligence model” refers to a computational model, such as a machine learning model or neural network, configured to generate output data, including at least control information for three-dimensional shape generation, in response to input data such as image data and prompt sentences.

The term “prompt” refers to information, including at least a prompt sentence and optionally associated image-related information, that is provided as input to a generative artificial intelligence model to guide generation of output data.

The term “conditions for generation of a three-dimensional shape” refers to parameters or constraints that describe desired properties of a three-dimensional shape, including at least geometric characteristics, structural layout, or level-of-detail requirements.

The term “control information” refers to structured data output by a generative artificial intelligence model that specifies how a three-dimensional shape is to be generated or modified, including at least structural parameters and material parameters.

The term “structural parameters” refers to values that define geometric or topological properties of a three-dimensional shape, such as dimensions, counts of repeated elements, proportions, or spatial arrangements of components.

The term “material parameters” refers to values that define surface or appearance properties of a three-dimensional shape, such as color, reflectivity, transparency, roughness, texture usage, or other rendering-related attributes.

The term “script” refers to a sequence of machine-executable instructions, typically expressed in a high-level scripting language, that is configured to control operations of software components such as a three-dimensional shape editing software application.

The term “application programming interface” refers to an interface exposed by software that defines callable functions, methods, operations, or data structures through which other software components, including scripts, can control the behavior of the software.

The term “three-dimensional shape editing software” refers to an application program or software library configured to create, modify, and manage three-dimensional geometric data, including at least meshes, surfaces, and associated materials or textures.

The term “three-dimensional shape data” refers to digital data representing a three-dimensional object, including at least information regarding vertex positions, edges, faces, and optionally material assignments, texture coordinates, and other geometric attributes.

The term “surface information” refers to data associated with a surface of a three-dimensional object, including at least texture data, color data, or other parameters that influence visual appearance of the surface.

The term “three-dimensional model file format” refers to a standardized digital file structure that encodes three-dimensional shape data, including at least geometric information and optionally material and texture references, in a form interoperable with external software applications.

The term “virtual environment” refers to a computer-generated three-dimensional space in which digital objects are placed and rendered, and in which a user can perceive or interact with such objects through a display device and optionally input devices.

The term “electronic game program” refers to executable software that provides interactive entertainment by rendering a game world, processing user input, and updating game state, including at least use of three-dimensional models for visual representation.

The term “downloadable” refers to being accessible through a network such that data can be transferred from a server to a terminal device and stored on the terminal device for later use.

The term “digital content” refers to electronically stored media or data, including at least visual, audio, or interactive elements, that can incorporate three-dimensional models for presentation or interaction.

The term “distribution network service” refers to a network-based service, such as an online platform or content delivery infrastructure, configured to deliver digital content from a server to one or more terminal devices and to manage access to such content.

The term “consideration” refers to compensation or value received in exchange for provision of digital content or services, including at least monetary payment, usage fees, or other measurable value.

The term “user operation” refers to an action performed by a user via a terminal device, including at least selection, input, or manipulation operations through a user interface.

The term “additional prompt sentence” refers to a second or subsequent prompt sentence expressed in natural language that is provided after an initial prompt sentence to request modification or refinement of a generated three-dimensional shape.

The term “updated control information” refers to control information that has been newly generated or modified by a generative artificial intelligence model in response to a user operation or additional prompt sentence, and that is used to adjust existing three-dimensional shape data.

The term “display format” refers to a manner in which three-dimensional shape data is visually presented, including at least rendering style, level of detail, viewpoint configuration, shading mode, or other visual presentation settings.

In one embodiment, a server implements the claimed system using a hardware platform that includes at least one central processing unit (CPU), an optional graphics processing unit (GPU), a main memory device, a non-volatile storage device, and a network interface. The server executes an operating system such as a general-purpose server operating system and runs middleware including a web server component, an application framework component, and a three-dimensional shape editing software component. The server communicates with one or more terminal devices operated by users through a communication network.

A terminal includes a processor, a memory, a display device, and input devices, and executes a web browser or a dedicated client application. The user operates the terminal to transmit two-dimensional image data and at least one prompt sentence to the server. The prompt sentence is expressed in natural language and describes desired conditions for generation of a three-dimensional shape. Examples of the prompt sentence include:

“Please generate a detailed 3D model of this building facade suitable for a game engine.” “Generate a realistic mid-rise office building 3D model from this facade image, with 6 floors and glass windows, optimized for Unreal Engine.”

“Create a low-poly 3D facade model suitable for a mobile game from this uploaded texture.” “From this front image, generate a simplified 3D building block for quick architectural visualization.”

The server receives two-dimensional image data and the prompt sentence and stores the received data in non-volatile storage through file system APIs. The server uses an image processing library, such as a library for manipulating raster image data, to decode the two-dimensional image data into an internal pixel array representation in main memory. The server analyzes a format, a resolution, a pixel count, a color mode, and metadata fields of the two-dimensional image data and, when necessary, performs normalization operations such as conversion to a predetermined color space, resampling to a target resolution, and re-encoding into a standard internal file format.

The server represents the standardized image data as a structured data object that includes at least a file path to the normalized image, numeric values representing width and height in pixels, a color mode identifier, and flags indicating whether additional metadata is present. By normalizing the image data into a fixed representation, the server avoids repeated format conversion in downstream processing and reduces memory fragmentation. This improves data management and enables more efficient caching and reuse of image buffers inside the memory hierarchy.

The server generates a textual context description of the image for a generative AI model input. In one embodiment, the server constructs a context string that combines the prompt sentence, the image metadata, and system-level instructions that specify the type of three-dimensional shape to be generated. For example, the server may generate a context such as: “System: You are a 3D modeling assistant that outputs structured parameters for building facades. User prompt: ‘Please generate a detailed 3D model of this building facade suitable for a game engine.’ Image info: width=4096, height=2048, use as facade texture.”

The server uses a generative AI model implemented as a neural network architecture that processes the prompt sentence and the context description. In one embodiment, the generative AI model is a transformer-based sequence model with multiple attention layers, a multi-head self-attention mechanism, and feed-forward sub-layers. The server stores model parameters, including weight matrices and bias parameters, in non-volatile memory, and loads them into main memory when the model is initialized. The model processes tokenized representations of the prompt sentence and context, where the server converts the prompt sentence into a sequence of tokens using a subword tokenization scheme and embeds the tokens into continuous vector representations using trained embedding matrices.

The server configures the generative AI model to output structured control information rather than only free-form natural language. For example, the server defines an output schema including fields such as total height, number of floors, number of columns, extrusion depth, window width, window height, material categories, and surface roughness parameters. The server trains or fine-tunes the generative AI model so that its output tokens correspond to key-value pairs or a constrained grammar that can be parsed deterministically.

In a training phase, the server prepares training data that includes pairs of (prompt sentence, image context) and corresponding ground-truth control information. The server applies supervised learning by feeding the training pairs into the generative AI model and computing a loss function such as a cross-entropy loss between predicted token sequences and ground-truth token sequences. The server applies gradient-based optimization (for example, stochastic gradient descent with adaptive learning rate) to update the model weights. The server may additionally use regularization techniques such as dropout in attention and feed-forward layers, and may augment training data by varying phrasing of prompt sentences and perturbing image metadata, thereby improving robustness and generalization.

By constraining the generative AI model to produce machine-parsable control information, the server reduces post-processing overhead and avoids free-form interpretation by a human operator. This design yields a non-conventional data flow where the model's output is directly consumable by a three-dimensional shape editing software without manual translation. As a result, processing latency is reduced, and the probability of human interpretation errors is lowered.

When the generative AI model is used in inference mode, the server provides, as input, the tokenized prompt sentence and the tokenized context description derived from the standardized image data. The model performs a series of matrix multiplications, attention score calculations, and non-linear activations to compute an output token sequence. The server decodes the output token sequence and maps it into structured control information comprising structural parameters and material parameters. This mapping may use delimiters or fixed token positions to identify parameter names and numeric values.

The server stores the control information in an intermediate data structure, such as a dictionary or record, in main memory. This intermediate data structure defines geometry parameters (for example, number of floors, number of window columns, approximate dimensions, extrusion depths) and material parameters (for example, base color identifiers, metallic and roughness coefficients, texture usage flags). This structured data serves as a compact, machine-readable specification that can be transferred efficiently between modules within the server.

The server uses the structured control information and the standardized image data to control three-dimensional shape editing software. In one embodiment, the server executes a scripting environment provided by the three-dimensional shape editing software and issues calls through an application programming interface (API). The server's script creates mesh objects, defines vertices, edges, and faces according to the structural parameters, and applies the standardized image data as texture to specific faces using texture coordinates computed from the control information.

The server constructs three-dimensional geometry in a non-traditional way compared to manual modeling. For example, rather than directly placing vertices by hand, the server generates a parametric grid structure based on the number of floors and columns produced by the generative AI model. The server computes vertex positions using arithmetic operations that distribute vertices evenly across the facade plane or adjust them in a non-uniform manner based on high-level semantic attributes. This parametric approach allows the server to reuse the same computational template for many different facades with varying dimensions, thereby improving computational efficiency and reusability.

The server maps the standardized image data to the three-dimensional surface by generating UV coordinates. The server may use a rule-based UV layout in which the image is stretched to cover the entire facade area, or the server may segment the image into regions corresponding to windows, doors, and walls based on inferred pattern information. In one embodiment, the server employs a lightweight pattern detection algorithm that analyzes luminance and edge density across the image to detect recurring window-like regions. The server encodes detected region boundaries as feature points and uses these feature points to align UV islands in the three-dimensional shape editing software. This algorithmic mapping yields improved texture alignment without manual intervention and reduces artifacts such as stretching or misalignment.

The server converts the resulting three-dimensional shape data into a standardized three-dimensional model file format, such as a polygon mesh file format that stores vertex coordinates, face indices, material assignments, and references to texture images. The server uses export functions of the three-dimensional shape editing software to write the three-dimensional model files to non-volatile storage. By using established file formats, the server ensures interoperability with external applications, including virtual environment engines and electronic game programs.

The server then exposes the generated three-dimensional model files through a network-accessible endpoint. The server generates unique identifiers or paths for each generated file and associates them with a user session in a database. The terminal accesses the server endpoint, and the user downloads the three-dimensional model files through the terminal. The user can then import the files into external three-dimensional engines, visualization systems, or simulation environments. In these external systems, the three-dimensional models participate in lighting calculations, collision detection, animation, and rendering pipelines, thereby connecting the server's processing to concrete technical usage in real-time rendering and simulation.

The server may also embed the generated three-dimensional shape data into other digital content. For example, the server may integrate the three-dimensional model into an interactive scene graph description, a virtual showroom, or a training simulation. The server's embedding process includes associating the three-dimensional model with scene metadata such as coordinates, interaction triggers, and physics parameters. By constructing such integrated digital content, the server enables downstream systems to load entire virtual scenes containing the generated models without additional manual configuration.

The described arrangement is not a mere automation of a human workflow. A human operator typically cannot evaluate high-dimensional token representations, perform attention-based computations, or manage large numbers of parametric variations with the same speed or consistency. The generative AI model processes the prompt sentence and the image context according to internal rules driven by trained weight matrices and attention distributions that are not directly replicable by simple human reasoning. The server leverages these model-internal computations to generate structured control information that is tightly coupled to the three-dimensional geometry generation pipeline.

The server's architecture improves core computer technology in several ways. First, by structuring the generative AI model's output as concise control information instead of raw image data or free-form text, the server reduces memory usage and data transmission overhead within the system. The control information captures essential geometric and material semantics in a compressed representation, which leads to more efficient storage and faster access compared to storing multiple intermediate mesh variants or large auxiliary images.

Second, the server reduces processing latency by avoiding redundant operations. Because the image is normalized once and reused in standardized form, downstream modules do not need to re-parse or re-decode the image. Also, because the AI output is already parameterized, the server does not need to perform complex natural language parsing or manual interpretation of unstructured text to derive geometry. This layered architecture leads to faster generation of three-dimensional models, particularly when processing a large number of input images. Third, the server improves accuracy and repeatability of three-dimensional model generation. The generative AI model is trained using supervised learning with explicit ground-truth control information, causing the model to learn stable mappings from prompt sentences and image metadata to geometry parameters. The server reuses the same model for new inputs, so given similar prompt sentences and similar image characteristics, the server tends to produce consistent structural parameters. This consistency reduces errors due to human variability and supports reproducible generation, which is important in technical workflows such as architectural visualization and engineering simulation.

Fourth, the server improves data management by enforcing explicit data structures and module boundaries. The server separates raw image data, standardized image data, control information, three-dimensional shape data, and final file formats into logically distinct stages. Each stage uses defined schemas and interfaces, allowing the server to track processing steps, cache intermediate results, and selectively recompute only affected stages when an additional prompt sentence requests a model update. For example, when the user inputs an additional prompt sentence such as “Reduce the number of floors to 4 and make the windows larger,” the server can provide this additional prompt sentence to the generative AI model, obtain updated control information, and adjust only the geometry stage, reusing the standardized image data without repeating normalization.

In another embodiment, the server employs different types of generative AI models depending on the application. For building facades, the server may use a transformer model specialized for architectural semantics. For character models or vehicles, the server may apply a different model variant that outputs control information suited to articulated meshes or curved surfaces. The server selects an appropriate model based on metadata in the prompt sentence or user preferences. This modular design allows extensibility while maintaining the same overall data flow.

In yet another embodiment, the server performs optimization operations after generating the initial three-dimensional mesh. The server may apply mesh simplification algorithms, such as edge collapse with error metrics based on curvature or screen-space error, to reduce polygon count while preserving perceived shape. The server can decide the degree of simplification based on target platform information included in the prompt sentence, for example “optimized for mobile game” versus “optimized for high-end desktop rendering.” This dynamic optimization further improves computational efficiency and reduces communication load when models are distributed to resource-constrained devices.

The described system emphasizes technical processing within the server. The server manages complex data transformations-tokenization, embedding, attention computation, parametric mesh generation, UV mapping, and file export-according to predetermined, machine-implementable algorithms. By coupling the generative AI model with the three-dimensional shape editing software via structured control information and explicit APIs, the server creates an integrated computer system that improves throughput, memory usage, and error characteristics relative to conventional, fragmented workflows.

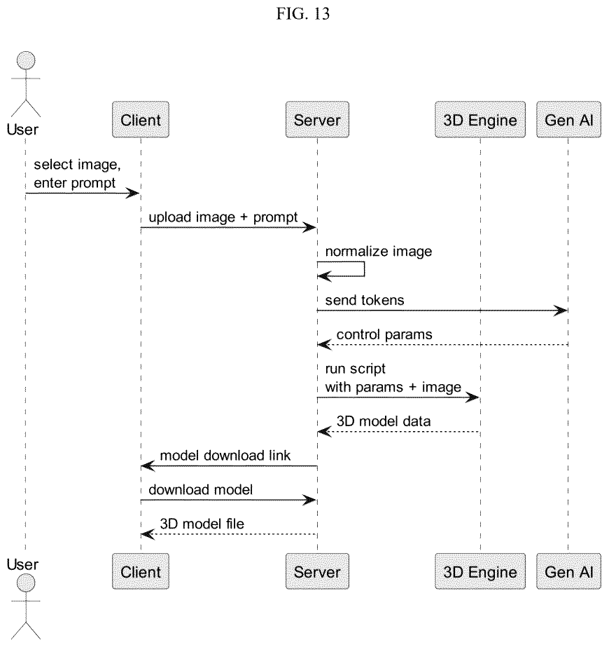

The following describes the processing flow using FIG. 13.

### Step 1:

The user operates the terminal to prepare input data.

The user launches a web browser or client application on the terminal, selects a local two-dimensional image file from storage, and types a prompt sentence in natural language. The input of this step is at least one two-dimensional image file and one prompt sentence displayed in an input field. The output of this step is user-selected image data and a text prompt ready to be transmitted from the terminal to the server.

### Step 2:

The terminal transmits the image data and the prompt sentence to the server.

The terminal executes client-side logic to package the binary image data and the prompt sentence into a network request, for example using a multipart/form-data format over HTTPS. The input of this step is the user-selected image data and the prompt sentence from Step 1. The terminal encodes the image bytes, encodes the prompt sentence as text, and sets appropriate headers such as content type and content length. The output of this step is a formatted network request containing the image and text data that is sent to the server.

### Step 3:

The server receives the network request and stores raw input data.

The server accepts the HTTPS request via a web server and application framework, parses the multipart/form-data, and extracts the binary image stream and the prompt sentence. The input of this step is the formatted network request produced by the terminal. The server allocates memory buffers, writes the image bytes to non-volatile storage, and stores the prompt sentence in a request context structure in memory. The output of this step is a stored image file at a server-side file path and an in-memory representation of the prompt sentence linked to that file path.

### Step 4:

The server normalizes the two-dimensional image data.

The server uses an image processing library to open the stored image file, decode the pixel data, and analyze format, resolution, and color mode. The input of this step is the server-side image file path and associated metadata from Step 3. The server performs data processing operations such as converting the color model to a standard format, resizing the image to a target resolution if necessary, and removing unsupported metadata. The server then writes the processed image to a new standardized file and constructs a standardized image data structure containing the new file path, width, height, and color mode. The output of this step is the standardized image data ready for use by downstream modules.

### Step 5:

The server generates a context string for the generative AI model.

The server combines the prompt sentence with information derived from the standardized image data, such as dimensions and intended usage as a texture, and formats them into a single textual context. The input of this step is the prompt sentence from Step 3 and the standardized image data from Step 4. The server performs string concatenation and template filling operations to encode image properties and user intent in a structured natural-language description. The output of this step is a context string that serves as a well-formed input for the generative AI model.

### Step 6:

The server tokenizes the prompt sentence and the context string.

The server applies a tokenizer compatible with the generative AI model to convert the prompt sentence and context string into sequences of discrete tokens. The input of this step is the text prompt and context produced in Steps 3 and 5. The server maps text substrings to integer token identifiers, constructs token sequences, and pads or truncates sequences to match the model's expected input length. The output of this step is a set of tokenized sequences, represented as arrays of integers that can be processed by the generative AI model.

### Step 7:

The server executes the generative AI model to obtain control information.

The server feeds the token sequences into a neural network model, which performs embedded vector computation, attention-based weighting, and layer-wise transformations. The input of this step is the tokenized sequences from Step 6. The server runs matrix multiplications, attention computations, and non-linear activations on the CPU or GPU according to the model architecture, and then decodes the resulting output token sequence into a structured representation. The output of this step is control information containing structural parameters and material parameters that describe a target three-dimensional shape.

### Step 8:

The server converts the model output into a machine-readable control structure.

The server parses the tokens or strings output by the generative AI model into key-value pairs, numerical arrays, or categorical labels that form a control data structure. The input of this step is the raw output of the generative AI model from Step 7. The server applies parsing rules and validation checks, converts textual or symbolic values into numeric formats, and ensures that parameter ranges are consistent and non-negative where required. The output of this step is a validated control information object that encodes geometry dimensions, repetition counts, and material attributes in a form usable by a three-dimensional shape editing software.

### Step 9:

The server prepares configuration data for three-dimensional shape generation.

The server aggregates the standardized image data and the control information into a configuration dataset consumed by a three-dimensional shape editing environment. The input of this step is the standardized image data from Step 4 and the control information from Step 8. The server combines file paths, numeric parameters, and material descriptors into a structured configuration record, optionally serializing this record to a temporary configuration file or passing it directly as in-memory data. The output of this step is configuration data that specifies how the three-dimensional shape should be constructed and how the standardized image data should be mapped to the surface.

### Step 10:

The server invokes the three-dimensional shape editing software with the configuration data.

The server launches a three-dimensional editing engine in a controlled execution environment and provides the configuration data as input to a scripting interface. The input of this step is the configuration data produced in Step 9. The server initiates a new editing session, loads required plugins or modules, and passes parameters to a script entry point so that the engine will construct geometry and apply textures according to the control information. The output of this step is an initialized three-dimensional editing context ready to generate a mesh based on the provided parameters.

### Step 11:

The server generates three-dimensional geometry from the control information.

The server, through the editing software's scripting API, creates a mesh object and computes vertex positions, edges, and faces using structural parameters such as number of floors, number of columns, and overall dimensions. The input of this step is the control information delivered to the scripting environment in Step 10. The server performs arithmetic operations to calculate coordinate grids, calls mesh-construction functions to instantiate geometric primitives, and subdivides or extrudes faces according to the structural parameters. The output of this step is a three-dimensional shape data object representing the geometry of the model in the editing software's internal data structures.

### Step 12:

The server maps the standardized image data as surface information.

The server imports the standardized image into the editing environment and attaches it as a texture to the generated mesh, creating necessary materials and UV mappings. The input of this step is the three-dimensional shape data from Step 11 and the standardized image data from Step 4 or Step 9. The server creates a material node graph, associates the image with a texture node, computes or assigns UV coordinates for each vertex or face, and links the texture to the surface shading pipeline. The output of this step is textured three-dimensional shape data in which the standardized image data is correctly mapped as surface information.

### Step 13:

The server converts the three-dimensional shape data into standard file formats.

The server exports the internal three-dimensional shape representation into one or more standardized three-dimensional model file formats that store geometry, materials, and texture references. The input of this step is the textured three-dimensional shape data from Step 12.

The server calls export functions, serializes vertex lists, face indices, material definitions, and file paths to texture images, and writes this information to non-volatile storage as model files.

The output of this step is a set of three-dimensional model files located at specific server-side file paths.

### Step 14:

The server generates download information for the terminal.

The server associates the generated three-dimensional model files with an identifier and constructs network-accessible URLs or equivalent references. The input of this step is the file paths and metadata of the model files produced in Step 13. The server records file locations and identifiers in a database or session store, generates unique links, and prepares a response payload that lists the available models and formats. The output of this step is download information that can be returned to the terminal to enable retrieval of the three-dimensional model files.

### Step 15:

The terminal receives the download information and initiates file retrieval.

The terminal processes the server's response, parses the download information, and presents selectable download options to the user through a user interface. The input of this step is the response containing download URLs from Step 14. The terminal updates its display, registers click handlers or equivalent actions, and, when the user selects a file, issues a request to the server to retrieve the selected model file. The output of this step is one or more network requests from the terminal to download the generated three-dimensional model files.

### Step 16:

The terminal stores the downloaded three-dimensional model files for further use.

The terminal receives the three-dimensional model file data streams from the server and writes them to local storage for later processing in external applications. The input of this step is the model file data transmitted in response to the terminal's download requests in Step 15.

The terminal buffers incoming bytes, verifies completion and integrity according to protocol rules, and commits the files to a user-specified directory in local storage. The output of this step is locally stored three-dimensional model files that the user can load into virtual environments or electronic game programs.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional three-dimensional content generation and presentation systems exhibit several technical limitations at the level of computer architecture and data processing pipelines. First, when transforming satellite-derived two-dimensional image data into three-dimensional representation data, existing systems rely on fixed, manually designed processing chains. Such rigid pipelines do not exploit dynamically generated processing procedures or control parameters, resulting in suboptimal use of computing resources, reduced automation, and limited adaptability to heterogeneous input data and device capabilities. This leads to inefficient generation of three-dimensional models, increased latency, and inconsistent quality across platforms.

Second, emotion-adaptive rendering and interaction control are typically implemented as static rule sets hard-coded into application logic on client devices or servers. These static rules neither leverage real-time emotion estimation results in a fine-grained manner nor utilize machine-generated adaptation logic. As a consequence, the display characteristics, audio characteristics, and operability of three-dimensional content are not continuously optimized based on changing emotional states of users and their interaction histories. This reduces system responsiveness, weakens user engagement, and fails to improve the underlying control algorithms and parameter-tuning mechanisms at runtime.

Third, generative artificial intelligence models are often used only to create content assets, and are not integrated as active components in the runtime control loop of three-dimensional rendering systems. In particular, existing systems do not systematically generate prompt sentences that encode satellite-image attributes, user behavior histories, and emotion states, nor do they use generative artificial intelligence model outputs to redesign control logic and parameter sets for rendering, audio, and interaction modules. Without such integration, the computing system cannot automatically refine processing procedures or optimize control parameters based on observed usage and emotion data, and thus cannot improve its own operation in a data-driven manner.

Fourth, in conventional environments, user-generated three-dimensional shape data and externally acquired three-dimensional data are incorporated into digital content through manual workflows and non-standardized formats. This lack of automated standardization, integration, and monetization support creates overhead for content creators and service providers, and prevents scalable deployment of user-generated models across diverse information processing terminals. The absence of unified handling of three-dimensional representation data and associated control information also hinders efficient distribution control and coordinated, cross-terminal interactivity.

Accordingly, there is a need for an improved computer-implemented system and server that (i) automatically generates and updates processing procedures and control parameters by using generative artificial intelligence models driven by structured prompt sentences, (ii) tightly integrates emotion estimation results into real-time adjustment of three-dimensional display, audio output, and interaction control, (iii) unifies asset formats and control logic for three-dimensional representation data across multiple terminals, and (iv) supports automated incorporation and monetization of user-generated or externally supplied three-dimensional shape data. Such a system should enhance the efficiency, adaptability, and scalability of three-dimensional content generation, distribution, and emotion-aware interaction at the level of the underlying computer technology.

The specific processing by the specific processing unit 290 of the data processing device 12 in Application Example 2 is realized by the following means.

The present invention provides a server comprising a processor configured to acquire two-dimensional image data obtained from a remote imaging platform, generate a prompt sentence for a generative artificial intelligence model on the basis of the two-dimensional image data and attribute information associated with the two-dimensional image data, and obtain, from the generative artificial intelligence model using the prompt sentence, processing procedure information or control parameter information related to three-dimensional structuring and texture assignment of the two-dimensional image data; to control an image processing unit and a three-dimensional shape generation unit on the basis of the processing procedure information or the control parameter information so as to generate three-dimensional shape data from the two-dimensional image data, to generate three-dimensional representation data by mapping the two-dimensional image data onto the three-dimensional shape data, and to convert the three-dimensional representation data into a plurality of kinds of standard data formats or terminal-adapted data formats; to acquire at least one of expression information, voice information, and operation information of a user, estimate an emotional state of the user by an emotion estimation processing unit, generate control information for dynamically adjusting at least one of a display control parameter, an audio control parameter, and an operation response parameter with respect to the three-dimensional representation data on the basis of the emotional state, and change in real time at least one of display characteristics, audio characteristics, and operability of the three-dimensional representation data on the basis of the control information; to transmit, to the generative artificial intelligence model, a prompt sentence including the emotional state, behavior history information of the user, and attribute information of the three-dimensional representation data, and to automatically redesign an update process of the display control parameter, the audio control parameter, and the operation response parameter on the basis of rule information or parameter optimization information acquired from the generative artificial intelligence model in response to the prompt sentence; and to distribute the three-dimensional representation data and the control information to a plurality of information processing terminals and execute distribution control for causing interactive presentation of the three-dimensional representation data on the plurality of information processing terminals. This enables the computer system to automatically generate and refine three-dimensional processing pipelines and control logic using generative artificial intelligence outputs driven by structured prompt sentences, to adapt rendering, audio output, and interaction behavior in real time based on estimated user emotions and behavior histories, to standardize and distribute three-dimensional representation data efficiently across heterogeneous terminals, and to improve the overall performance, scalability, and adaptability of three-dimensional content generation and emotion-aware presentation at the level of the underlying computer technology.

The term “processor” refers to an electronic data processing element, such as a central processing unit, a graphics processing unit, or a combination thereof, that executes instructions and performs arithmetic and logical operations to implement the functions described in the system.

The term “two-dimensional image data” refers to digital data representing visual information on a plane, composed of a plurality of picture elements arranged in two dimensions, and including, for example, texture images or photographs obtained by an imaging device.

The term “remote imaging platform” refers to an apparatus or system located away from the server, such as an artificial satellite, an aerial vehicle, or another remote sensing device, that captures images of a target region and outputs two-dimensional image data.

The term “attribute information” refers to metadata associated with two-dimensional image data or three-dimensional representation data, including, for example, position information, time information, resolution information, category information, and device information.

The term “prompt sentence” refers to a text-based instruction or query supplied to a generative artificial intelligence model that specifies a processing objective, constraints, or context for generating processing procedure information, control parameter information, or interaction design information.

The term “generative artificial intelligence model” refers to a machine learning model that generates output data, such as text, code, or parameter sets, in response to an input prompt, based on a learned probability distribution or learned patterns in training data.

The term “processing procedure information” refers to information describing a sequence of processing steps, operations, or algorithms to be executed by image processing units or three-dimensional shape generation units to transform input data into output data.

The term “control parameter information” refers to numerical values, thresholds, weights, or configuration settings used to control behavior of image processing, three-dimensional generation, rendering, audio processing, or interaction processing modules.

The term “image processing unit” refers to a hardware or software module that performs operations such as filtering, normalization, feature extraction, or transformation on two-dimensional image data in accordance with instructions from the processor.

The term “three-dimensional shape generation unit” refers to a hardware or software module that generates three-dimensional shape data, including vertices, edges, and faces, from two-dimensional image data, attribute information, or feature data.

The term “three-dimensional shape data” refers to data representing a geometric structure in three-dimensional space, including information regarding spatial coordinates of vertices, connectivity of edges, and surfaces or faces forming a three-dimensional object.

The term “three-dimensional representation data” refers to data representing a three-dimensional object or environment including both three-dimensional shape data and one or more associated visual attributes, such as mapped textures, material properties, or shading information.

The term “standard data format” refers to a widely used data encoding scheme for three-dimensional data, such as a mesh or scene description, which is defined by a publicly available specification and is interoperable across a plurality of information processing systems.

The term “terminal-adapted data format” refers to a data format or packaging of three-dimensional representation data that is optimized or configured for use on a particular class of information processing terminals, such as mobile devices, head-mounted displays, or web browsers.

The term “expression information” refers to data derived from an image or video of a user's face, indicating facial expressions or facial feature configurations that can be analyzed to estimate an emotional state.

The term “voice information” refers to audio data of a user's speech or vocal sounds, including waveform data or processed acoustic features, that can be analyzed to estimate an emotional state or other user characteristics.

The term “operation information” refers to data representing user interactions with a user interface, including inputs such as touch events, cursor movements, button presses, controller motions, or gesture commands.

The term “emotion estimation processing unit” refers to a hardware or software module that receives expression information, voice information, or other sensor data and outputs an estimated emotional state of a user based on an emotion recognition algorithm.

The term “emotional state” refers to an internal psychological state of a user, represented in the system by one or more labels or scores, such as joy, sadness, surprise, fear, calmness, or excitement, estimated from observed data.

The term “display control parameter” refers to a value or set of values that influence visual rendering of three-dimensional representation data, including parameters for brightness, color tone, contrast, camera position, viewpoint, animation speed, or visual effects.

The term “audio control parameter” refers to a value or set of values that influence audio output associated with three-dimensional representation data, including parameters for volume, equalization, effect intensity, track selection, or spatial audio positioning.

The term “operation response parameter” refers to a value or set of values that influence how the system responds to user input, including parameters for input sensitivity, response latency, damping, acceleration, and mapping of input events to actions.

The term “display characteristics” refers to observable visual properties of rendered three-dimensional representation data, including brightness, color tone, contrast, motion, viewpoint, and effect composition.

The term “audio characteristics” refers to observable acoustic properties of output audio, including loudness, frequency balance, reverberation, spatial localization, and temporal dynamics.

The term “operability” refers to a degree of ease and responsiveness with which a user can manipulate or navigate three-dimensional representation data through input devices or user interfaces.

The term “behavior history information” refers to information representing past interactions or actions of a user within the system, including logged operation information, navigation paths, selection histories, and temporal patterns of use.

The term “rule information” refers to information describing decision logic, mapping rules, or condition-action relationships used to determine how control parameters or processing procedures should be selected or updated.

The term “parameter optimization information” refers to information specifying optimized or recommended values, ranges, or update strategies for control parameters, determined based on performance criteria or observed data.

The term “distribution control” refers to control processing for selecting, transmitting, and managing three-dimensional representation data and associated control information to a plurality of information processing terminals in an appropriate format and timing.

The term “information processing terminal” refers to an electronic device capable of executing software instructions to present content and process user input, such as a personal computer, mobile terminal, head-mounted display, or other client device.

The term “three-dimensional shape data created by a user” refers to three-dimensional shape data generated by a user using a modeling tool or authoring application, and provided to the server for incorporation into content.

The term “three-dimensional shape data acquired from an external device” refers to three-dimensional shape data obtained from a device or system other than the present server, such as a modeling workstation, sensor system, or external content provider.

The term “information processing program” refers to a software application or executable module configured to process data, render three-dimensional representation data, and manage user interactions, such as a simulation program or an interactive content program.

The term “distribution platform” refers to an electronic service or infrastructure used to deliver digital content to information processing terminals, including, for example, application distribution services or content delivery networks.

The term “electronic commerce platform” refers to an electronic system that supports listing, selling, purchasing, and payment of digital or virtual goods and services, including digital content comprising three-dimensional representation data.

The term “usage result information” refers to information indicating how distributed content has been used, including metrics such as access counts, session durations, interaction frequencies, and completion rates.

The term “transaction information” refers to information related to commercial transactions of content or services, including purchase records, pricing data, user identifiers, and payment details.

The term “revenue distribution information” refers to information indicating allocation of monetary amounts or other consideration among multiple parties, such as content creators, platform operators, or rights holders.

The term “time-series change information of the emotional state” refers to information representing temporal variation of the estimated emotional state of a user, recorded as a sequence of emotion estimates over time.

The term “interaction design information” refers to information describing a structure or pattern of interactions between a user and three-dimensional representation data, including recommended control schemes, feedback behaviors, and interface flows.

The term “viewpoint movement speed” refers to a parameter indicating a rate at which a virtual camera or user viewpoint is moved within a three-dimensional scene in response to user input.

The term “magnification” refers to a parameter indicating a scale factor or zoom level applied to a three-dimensional representation when rendering the representation on a display.

The term “response delay” refers to a time interval between reception of user input and an observable change in the three-dimensional representation data, including delays intentionally introduced by control logic.

The term “emphasis of an attention target” refers to processing that visually or otherwise highlights a particular portion or object in three-dimensional representation data, using techniques such as brightness adjustment, outline rendering, scaling, or focus effects.

The term “presentation of guidance information” refers to output of explanatory, instructional, or navigational information to a user, such as tooltips, on-screen instructions, markers, or audio guidance associated with three-dimensional representation data.

In one embodiment, a server implements the claimed system as a network-accessible computing node including at least one general-purpose central processing unit, at least one graphics processing unit, a main memory, a non-volatile storage device, and a network interface. The server executes an operating system and one or more application programs that perform image processing, three-dimensional generation, emotion estimation coordination, and interaction control logic. The server is communicatively coupled to one or more terminals via a communication network, and each terminal includes at least one processor, a memory, a display device, at least one input device, and optionally a camera, a microphone, and biometric sensors.

The server stores two-dimensional image data obtained from a remote imaging platform, such as an artificial satellite or unmanned aerial vehicle. The server stores the two-dimensional image data in a structured data store, for example in an object storage system with keys, and associates each image with attribute information including geospatial coordinates, acquisition time, capturing device parameters, and semantic labels. The server stores the attribute information in a relational table or key-value map linked to the corresponding image objects.

The server uses an image processing library, such as a generic computer vision library, to perform preprocessing on the two-dimensional image data. The server normalizes color channels, resamples image resolution, and applies denoising filters. The server then extracts feature descriptors from the images using feature detection algorithms, such as scale-invariant feature transform, oriented FAST and rotated BRIEF, or histogram-based descriptors. The server stores extracted features in a feature vector data structure, e.g., multidimensional arrays, which are used as inputs to three-dimensional shape generation.

The server controls a three-dimensional shape generation unit implemented using a three-dimensional modeling framework, such as a polygon mesh generation engine. The server constructs three-dimensional shape data by combining two-dimensional features with elevation data or multi-view stereo correspondences. The server represents a mesh as arrays of vertex coordinates, face indices, and optional normal vectors. The server triangulates surfaces, performs mesh smoothing, and removes self-intersections. The server then produces three-dimensional representation data by associating texture coordinates with vertices and mapping the two-dimensional image data as textures onto the mesh surfaces using standard texture mapping algorithms.

The server uses content creation environments such as a game engine or a three-dimensional authoring tool to import the generated three-dimensional representation data. The server invokes scripting interfaces of the authoring tool to create materials, assign texture maps, and define level-of-detail variants. The server exports the three-dimensional representation data into standard data formats, such as mesh exchange formats or scene graph formats, and into terminal-adapted formats, such as engine-specific asset bundles for mobile terminals, compressed streaming formats for web browsers, or optimized binary packages for head-mounted displays. The server stores format metadata indicating which asset variant is appropriate for which class of terminal.

The server generates a prompt sentence for a generative AI model by programmatically assembling a textual description that encodes attributes of the two-dimensional image data and targeted three-dimensional processing. The server includes in the prompt sentence an indication of scene type, resolution constraints, desired polygon count, and target platforms. Example prompt sentences include:

“Using this satellite 2D texture data of an urban area, generate a detailed procedure and parameter set to build a realistic 3D city model suitable for deployment in a game engine and a web-based renderer.”

“Based on 2D texture data captured from a remote imaging platform, describe how to generate a low-polygon 3D terrain model and specify texture mapping and level-of-detail parameters for mobile terminals.”

The server submits the prompt sentence and compacted attribute information to a generative AI model implemented as a trained neural network. In one embodiment, the generative AI model is a transformer-based language model comprising multiple self-attention layers, feed-forward layers, and layer normalization components. The generative AI model has been trained with supervised or self-supervised learning on a corpus that includes code samples for 3D pipelines, configuration files, and descriptive technical text. During training, the generative AI model minimizes a cross-entropy loss between predicted tokens and ground-truth tokens, and updates model weights using a gradient descent optimizer with regularization terms for stabilizing convergence.

The server receives from the generative AI model a sequence of tokens that encode processing procedure information and control parameter information. The server parses this output into structured fields, for example by identifying delimiters or headings that define parameter names and values. The server extracts mesh resolution settings, texture filtering modes, and shader parameters, and also extracts algorithmic steps, such as “apply edge-preserving smoothing before feature detection” or “use a two-stage level-of-detail hierarchy with specified thresholds.” The server uses this extracted information to configure the image processing unit and the three-dimensional shape generation unit without requiring manual coding by an operator. This use of the generative AI model affects internal data structures, memory layouts, and processing sequences, thereby improving consistency and reducing misconfiguration errors when compared to manual setup.

The server further uses a generative AI model to design or refine runtime control logic for emotion-adaptive rendering and interaction. The server constructs another prompt sentence incorporating current and historical emotion states, user behavior history information, and three-dimensional representation attributes. Example prompt sentences include:

“For a VR horror experience where the current fear score is high and users tend to remain in dark regions, propose detailed rules and parameter ranges to adjust light intensity, color grading, audio levels, and camera motion in a game engine to enhance immersion while maintaining frame rate.”

“Given a virtual shop scene, user interaction logs, and emotion labels indicating fatigue during long sessions, describe how to adjust navigation sensitivity, highlight important products, and change background music to reduce cognitive load.”

The server passes such prompt sentences to the generative AI model, which outputs rule information and parameter optimization information in text form. The server maps the outputs into rule tables or decision graphs that relate emotion scores and interaction context to specific parameter updates. For example, the server may store a rule table where rows represent discrete emotion intensity bins and columns represent display control parameters, and the cell values represent multipliers or offsets. This mapping enables the server to implement non-linear, context-sensitive adaptations that are not easily expressed by fixed, hand-crafted rules.

The terminal acquires expression information and voice information by operating a camera and microphone under program control. The terminal periodically captures image frames, downsamples them, and extracts facial landmarks using a convolutional neural network trained for facial feature detection. The terminal converts audio into spectral features using short-time Fourier transform or mel-frequency cepstral coefficients. The terminal forwards the extracted features to an emotion estimation processing unit, which may run locally or remotely. In one embodiment, the emotion estimation processing unit uses a neural network with convolutional layers for visual features and recurrent or transformer layers for temporal aggregation. The model outputs probability distributions over emotion categories and continuous arousal-valence scores. The model has been trained with labeled emotion datasets using a loss function that combines categorical cross-entropy and mean squared error.

The server or the terminal converts the emotion outputs into an emotional state representation stored as numeric vectors. The server maintains a time-series of these vectors in a session buffer. The server calculates time-series change information, such as derivative or moving average of emotion scores, and uses this information to smooth transient noise and to identify sustained emotional trends. This processing reduces spurious adaptation and improves stability of rendering and interaction parameters.

The server generates control information for dynamically adjusting display control parameters, audio control parameters, and operation response parameters by applying the previously generated rule tables and parameter optimization information to the current emotional state and behavior history. For example, the server computes a new brightness value as a function of current arousal score and past engagement time, and computes a new camera rotation sensitivity as a function of excitement score and motion sickness indicators derived from interaction logs. The server packages these parameter values into configuration messages and transmits them to terminals over low-latency channels.

The terminal receives configuration messages and applies them directly within a rendering engine. The terminal updates shader uniform variables, such as exposure, color balance, and saturation; adjusts light source intensities; and modifies animation speed multipliers. The terminal also updates audio mixer settings, such as volume curves, filter coefficients, and selected soundtracks, and modifies input mapping data structures controlling camera movement speed, damping factors, and interaction thresholds. These modifications are applied in the rendering pipeline and audio pipeline on a per-frame basis or at discrete time intervals. As a result, the rendered three-dimensional representation data and audio output adapt in real time to changes in the user's emotional state, while maintaining frame rate and resource constraints.

The use of generative AI model outputs to define procedure sequences and parameter spaces improves computer technology in several ways. First, by automatically deriving optimized combinations of preprocessing steps, three-dimensional generation parameters, and rendering configurations for each input dataset and target device class, the server reduces trial-and-error by human engineers and achieves more consistent computational efficiency. The server can reduce processing time through selection of lightweight algorithms when appropriate, and can reduce memory footprint by adjusting geometry complexity and texture resolution according to device capabilities. Second, by using model-generated rules for emotion-adaptive control, the server optimizes both responsiveness and smoothness, thereby reducing unnecessary oscillations in parameters and avoiding visual artifacts or audio glitches. This improves overall system stability and user-perceived quality.

The server supports ingestion of user-created or externally acquired three-dimensional shape data. The user operates a three-dimensional modeling application on a terminal to create a shape, assigns materials or textures, and exports the shape in a standard format. The terminal transfers the exported file to the server, which validates geometry, repairs mesh errors, and converts the shape into the same internal representation used for satellite-derived meshes.

The server assigns consistent material templates and adds the shape to a content catalog. The server may also submit a prompt sentence to a generative AI model requesting recommendations for integrating the user-created shape into existing scenes or for generating variants. For example, a prompt sentence may be:

“Explain how to integrate a user-created 3D building model into a city scene and propose material and lighting adjustments so that the building visually matches satellite-derived surroundings.”

The server uses the response to automatically assign environment-specific materials and lighting parameters, reducing manual integration effort and improving visual consistency.

The server distributes three-dimensional representation data and associated control information to a plurality of terminals. The server selects an appropriate asset variant for each terminal based on device profile information, such as display resolution, processor capability, and network conditions. The server manages asset caching and streaming, and may adapt bitrates or level-of-detail based on measured latency and packet loss. This asset selection and streaming logic reduces communication load and avoids transmitting unnecessarily large assets to low-capability terminals, providing a direct improvement in communication efficiency and bandwidth usage.

The terminal renders the received three-dimensional representation data using a graphical processing pipeline. The terminal uses a vertex processing stage, a rasterization stage, and a fragment processing stage implemented on a graphics processing unit. The terminal applies transformations, lighting calculations, and texture sampling according to control parameters specified by the server. By centralizing parameter determination on the server and distributing only numerical values and simple configuration messages to terminals, the system reduces per-terminal computation required for decision making and allows coordinated adaptation across terminals.

The user interacts with the three-dimensional representation data through input devices, such as touchscreens, pointing devices, game controllers, or gesture sensors. The user rotates, translates, and scales objects, navigates through environments, and selects interactive elements. The terminal logs interaction events with timestamps and sends them to the server, which aggregates behavior history information. The server uses the behavior history information, together with emotion trends, to generate new prompt sentences for the generative AI model that request updated interaction design information. The server may ask:

“Based on recorded interaction logs showing frequent abrupt camera movements and increased motion sickness reports, propose interaction design changes for camera control sensitivity and viewpoint limits.”

The server receives structured suggestions, translates them into updated rule tables and parameter defaults, and thereby refines the control logic of the entire system over time. This continuous refinement mechanism allows the system to improve interaction stability and user comfort at the level of computation, beyond simply automating existing manual adjustments. In alternative embodiments, the server may deploy different neural network architectures for the generative AI model or the emotion estimation processing unit. For example, the generative AI model may incorporate additional encoder components to process structured feature vectors alongside text tokens, or may incorporate reinforcement learning fine-tuning to optimize prompts for latency and accuracy of downstream pipelines. The emotion estimation model may use a multi-branch architecture that processes vision and audio in parallel and fuses their representations via attention mechanisms, and may be trained with data augmentation techniques such as random cropping, color jitter, and noise injection to increase robustness. The system may also support different data structures for control information, such as hierarchical parameter groups or graph-based scene control structures, to better match different rendering engines.

In another embodiment, some or all of the processing performed by the server may be deployed on edge nodes located closer to the terminals, such as gateway devices in a local network. The edge nodes may locally apply generative AI model outputs received from a central server to adapt rendering pipelines, reducing round-trip latency for control information. In yet another embodiment, certain terminals with sufficient computational capability may locally execute a compact generative AI model that receives prompt sentences and produces parameter updates without involving the server for each change, thereby offloading processing and reducing network traffic.

Across these embodiments, the system does not merely replicate a human designer's manual sequence of steps. Instead, the system encodes a non-conventional flow in which generative AI models output machine-readable procedure and control specifications that are integrated into the image processing, three-dimensional generation, and rendering pipelines, and are further refined using real-time emotion and behavior data. This integration changes how the computer system selects algorithms, configures parameters, and manages data flows, providing measurable improvements in processing speed, parameter tuning accuracy, resource usage, and cross-device consistency.

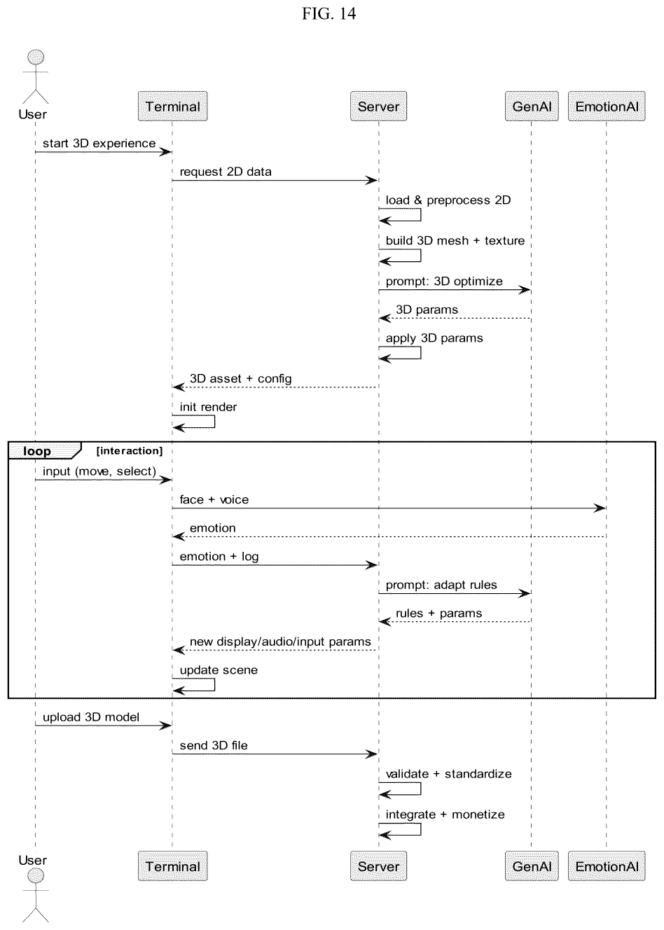

The following describes the processing flow using FIG. 14.

### Step 1:

Server acquires two-dimensional image data and attribute information from a remote imaging platform.

Server uses a network interface to receive image files (input: raw pixel data, e.g., arrays of RGB values) and metadata (input: geolocation, timestamp, sensor parameters) via a communication protocol. Server performs a data integrity check, such as verifying checksums and header formats, and stores the image data in an object store and the attribute information in a relational table (output: stored image objects keyed by IDs and linked attribute records).

Server thereby converts unstructured incoming streams into indexed, queryable data structures.

### Step 2:

Server preprocesses the two-dimensional image data and extracts visual features.

Server reads a selected image and its attributes from storage (input: stored image object and metadata) and applies image normalization, resizing, and denoising using an image processing library. Server then runs feature detection and description algorithms (for example, computing keypoints and descriptors) to extract salient features (output: feature vectors and keypoint coordinates). Server thus transforms dense pixel data into compact numerical descriptors that are more suitable for subsequent geometric reconstruction.

### Step 3:

Server generates initial three-dimensional shape data from the two-dimensional features.

Server takes feature vectors, keypoint coordinates, and optional depth or elevation data as input (input: feature sets and elevation samples) and runs a three-dimensional reconstruction algorithm, such as triangulation or height-map extrusion. Server computes vertex positions in three-dimensional coordinates, constructs faces by connecting vertices according to a meshing scheme, and calculates normal vectors (output: three-dimensional mesh data containing vertices, faces, and normals). Server thereby converts planar information into a geometric structure that can be rendered in three-dimensional space.

### Step 4:

Server maps the two-dimensional image data as textures onto the three-dimensional mesh.

Server takes the mesh data and original two-dimensional image as input (input: mesh vertices and pixel array) and calculates texture coordinates by projecting three-dimensional vertices onto the two-dimensional image plane. Server assigns UV coordinates to each vertex and defines material records that reference the image as a texture (output: textured three-dimensional representation data combining geometry and mapped textures). Server thereby produces a visually realistic three-dimensional representation from satellite imagery.

### Step 5:

Server generates a prompt sentence for a generative AI model to refine the three-dimensional processing pipeline.

Server gathers attribute information (scene type, resolution, target device class) and internal processing status (current mesh complexity, error metrics) as input (input: metadata and processing logs) and concatenates them into a textual description following a predefined template. Server forms a prompt sentence such as “Using this 2D satellite texture of an urban area, propose a detailed procedure and parameter set to optimize 3D city model generation for mobile and web rendering” (output: structured text prompt). Server thus encodes technical requirements and context into a form consumable by the generative AI model.

### Step 6:

Server queries the generative AI model with the prompt sentence and parses the response.

Server sends the prompt sentence to the generative AI model via an API (input: text prompt) and receives a sequence of tokens describing recommended processing steps and parameter values (output: model-generated text). Server then parses the text by detecting delimiters, parameter labels, and step headings to extract structured elements such as “use lower-resolution textures for distant objects” and numerical parameters like “target polygon count=100 k” (output: structured procedure information and control parameter information). Server thereby converts free-form model output into machine-usable control data.

### Step 7:

Server applies the procedure information and control parameters to reconfigure the image processing and three-dimensional generation units.

Server takes the structured procedure and parameter information as input (input: algorithm sequence and parameter set) and updates configuration files or in-memory settings of the image processing unit and the three-dimensional shape generation unit. Server adjusts, for example, the choice of filters, sampling rates, mesh decimation thresholds, and level-of-detail settings (output: updated configuration state of processing modules). Server thereby changes subsequent data transformations in a way that reflects optimized strategies produced by the generative AI model.

### Step 8:

Server converts the three-dimensional representation data to multiple standard and terminal-adapted formats.

Server loads the master three-dimensional representation data (input: textured mesh and materials) and invokes export routines of a three-dimensional engine or modeling tool. Server generates mesh files, scene graphs, or asset bundles for different targets (for example, high-detail format for workstations and compressed format for mobile devices) (output: a set of files in formats such as mesh exchange, scene description, and engine-specific bundles).

Server also records metadata linking each format to compatible terminal types (output: format mapping table). Server thus prepares the data for efficient cross-platform distribution.

### Step 9:

Server selects and distributes appropriate three-dimensional assets and control profiles to terminals.

Server receives a request from a terminal that includes device capabilities and network conditions (input: terminal profile and request identifier) and queries the format mapping table to choose a suitable asset variant. Server packages the selected three-dimensional data together with initial control parameters (display, audio, and interaction defaults) (output: response payload containing asset and configuration). Server sends the payload over the network, thereby reducing bandwidth usage by avoiding unnecessarily large or complex assets for constrained terminals.

### Step 10:

Terminal receives and stores the three-dimensional representation data and control parameters.

Terminal processes the network response (input: payload with assets and configuration) and stores the three-dimensional files in local memory or cache. Terminal parses the control parameters and initializes internal structures of a rendering engine, such as material instances, shader settings, and input sensitivity profiles (output: ready-to-render scene configuration).

Terminal thus prepares a local rendering environment tuned to its hardware and the server's guidance.

### Step 11:

Terminal initializes rendering of the three-dimensional representation data.

Terminal loads the three-dimensional assets into a graphics pipeline (input: mesh files, textures, and materials) and creates vertex buffers, index buffers, and texture objects on a graphics processing unit. Terminal sets up camera parameters, lighting, and default animation states based on the received configuration (output: initial frame buffer content representing the three-dimensional scene). Terminal then presents the rendered image on a display device.

Terminal thereby converts static asset data into an interactive visual environment.

### Step 12:

Terminal acquires user operation, expression, and voice information during interaction.

Terminal runs input handlers and sensor capture routines (input: signals from touch sensors, controllers, camera frames, microphone audio) and packages these signals into operation logs and sensor feature streams (output: operation information, facial image frames, and audio segments). Terminal time-stamps each record and stores them in temporary buffers. Terminal thereby collects raw data necessary for emotion estimation and interaction analysis.

### Step 13:

Server or terminal estimates the user's emotional state from captured signals.

Server or terminal feeds the facial frames and audio features into an emotion estimation processing unit (input: visual and audio features) and runs a trained neural network that outputs emotion probabilities and continuous scores (output: emotional state vector, e.g., joy, fear, arousal, valence). The neural network performs matrix multiplications and non-linear activations to infer emotion from features. Server or terminal stores the emotional state together with timestamps (output: time-series of emotion states). This step converts low-level sensor data into high-level emotional descriptors.

### Step 14:

Server aggregates emotional states and behavior history to compute time-series change information.

Server receives periodic emotional state updates and operation logs from the terminal (input: emotion vectors and interaction events) and aligns them on a time axis. Server computes moving averages, derivatives, and statistical summaries such as “average arousal over last 30 seconds” (output: time-series change information and behavior history features). Server thus transforms discrete measurements into smoothed, context-rich indicators of user experience.

### Step 15:

Server generates a prompt sentence for emotion-adaptive control using emotional and behavioral data.

Server composes a text description that includes current emotional state, time-series trends, behavior patterns (for example, frequent abrupt rotations), and scene type (input: emotion summaries and scene metadata). Server formulates a prompt sentence such as “For a virtual shop scene where user fatigue is increasing and interaction speed is decreasing, propose rules to adjust lighting, product highlighting, and navigation sensitivity to maintain engagement” (output: emotion-context prompt). Server thereby encodes complex runtime context into a single text query for the generative AI model.

### Step 16:

Server obtains interaction design information and parameter optimization information from the generative AI model.

Server sends the emotion-context prompt to the generative AI model (input: text prompt) and receives a response that describes recommended rules and parameter ranges (output: text describing interaction design and parameter values). Server parses the response, extracting specific directives such as “reduce camera rotation speed by 20% when fatigue score exceeds threshold” or “increase brightness of highlighted items when joy probability is high” (output: structured rule information and optimization values). Server converts narrative suggestions into numerical rules that can be implemented programmatically.

### Step 17:

Server computes updated display, audio, and operation response parameters based on rule information.

Server takes current emotional state, behavioral features, and rule tables as input (input: emotion vector, behavior summary, and rule information) and evaluates conditions specified in the rules. Server calculates new parameter values, such as updated brightness multipliers, audio volume curves, and input sensitivity coefficients, using arithmetic operations, interpolation, or look-up tables (output: updated control parameter set). Server packages these parameter sets into compact configuration messages for terminals.

### Step 18:

Terminal applies updated control parameters to the rendering, audio, and input pipelines.

Terminal receives configuration messages from the server (input: updated display, audio, and interaction parameters) and writes new values into engine-specific structures, such as shader constants, light intensity fields, audio mixer knobs, and input mapping tables (output: modified rendering state, audio state, and input response state). Terminal then uses the new parameters in subsequent frames, causing visible and audible modifications in the three-dimensional scene. Terminal thus converts high-level control information into low-level hardware-driven changes.

### Step 19:

User interacts with the adapted three-dimensional environment.

User observes the adjusted visuals and audio (input: displayed frames and sound output) and operates input devices accordingly (output: new operation events). For example, user rotates a 3D object, navigates within a virtual tour, or selects a product in a virtual shop. User perception of smoother camera motion or more comfortable audio may lead to different interaction patterns, which are recorded and fed back into the system in later iterations.

### Step 20:

Server ingests user-created or external three-dimensional shape data and standardizes it.

Server receives uploaded mesh files from a terminal (input: user-created or external 3D shape files in standard formats) and validates geometry, checking for non-manifold edges, inverted normals, or missing texture references. Server then converts the shapes into the same internal representation as satellite-derived meshes, reassigns materials according to system templates, and stores the converted data in the asset repository (output: standardized three-dimensional shape data ready for integration). Server thereby unifies different content sources under a common data model.

### Step 21:

Server integrates standardized three-dimensional shapes into content scenes and associates monetization metadata.

Server selects one or more standardized shapes (input: standardized 3D assets and scene definitions) and inserts them into existing scenes using a scene graph editor or programmatic placement. Server attaches metadata such as creator ID, licensing terms, and pricing information (output: updated scene configurations and monetization records). Server later publishes these scenes through distribution platforms, enabling the system to track usage and revenue, while maintaining technical control over asset integration.

### Step 22:

Server monitors system performance and adjusts pipelines using additional prompt sentences when needed.

Server continuously collects telemetry including frame rates, network throughput, error logs, and user engagement metrics (input: performance and usage metrics) and analyzes them to detect bottlenecks or anomalies. When the server observes persistent issues, such as low frame rate on certain device classes, the server generates a new prompt sentence asking the generative AI model to propose alternative pipeline configurations or parameter limits (output: optimization prompt and resulting recommendations). Server applies the new recommendations to update algorithm choices or parameter bounds, further refining the system's technical behavior over time.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

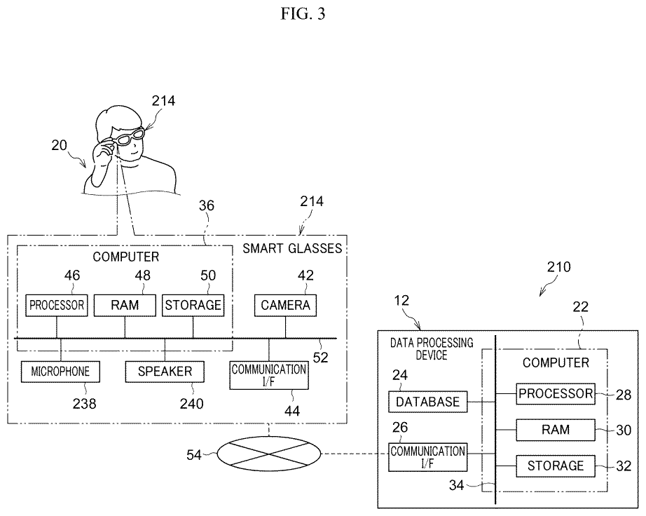

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

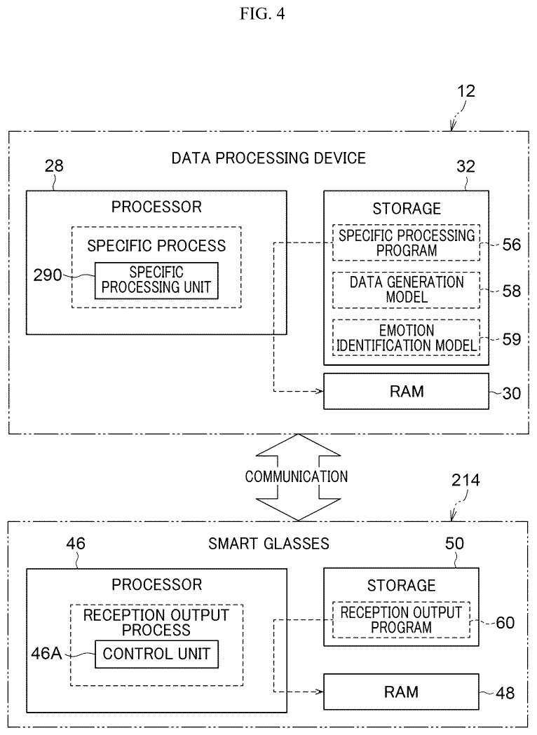

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

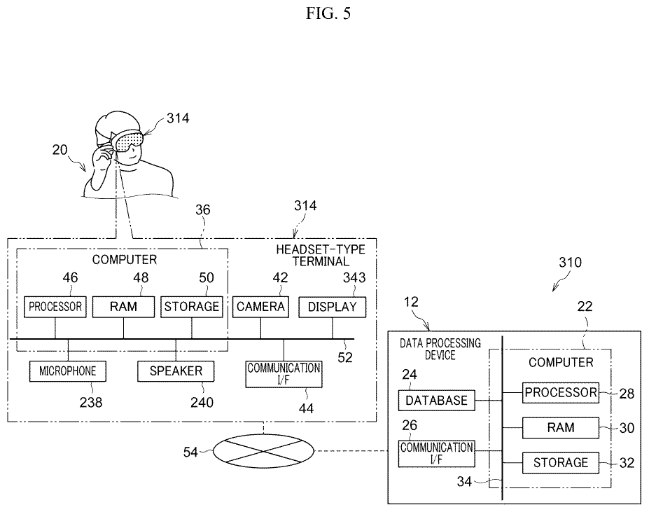

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

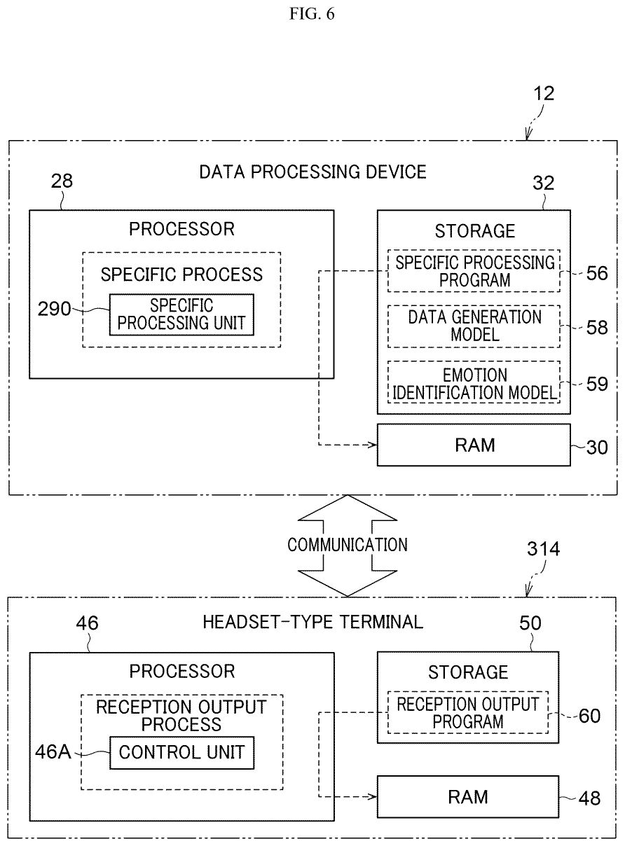

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

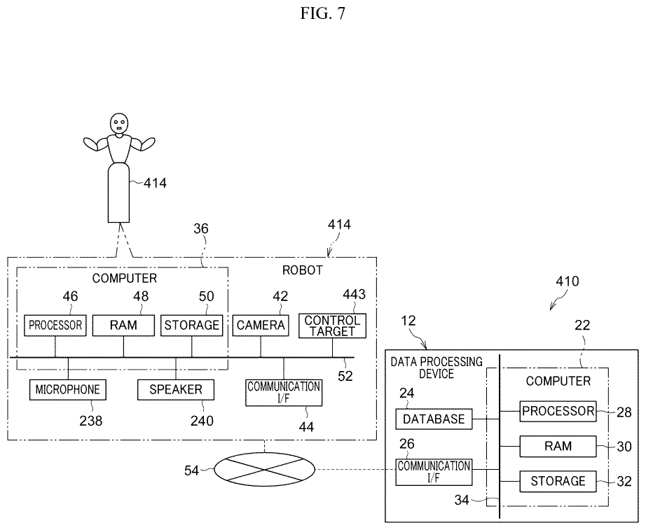

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

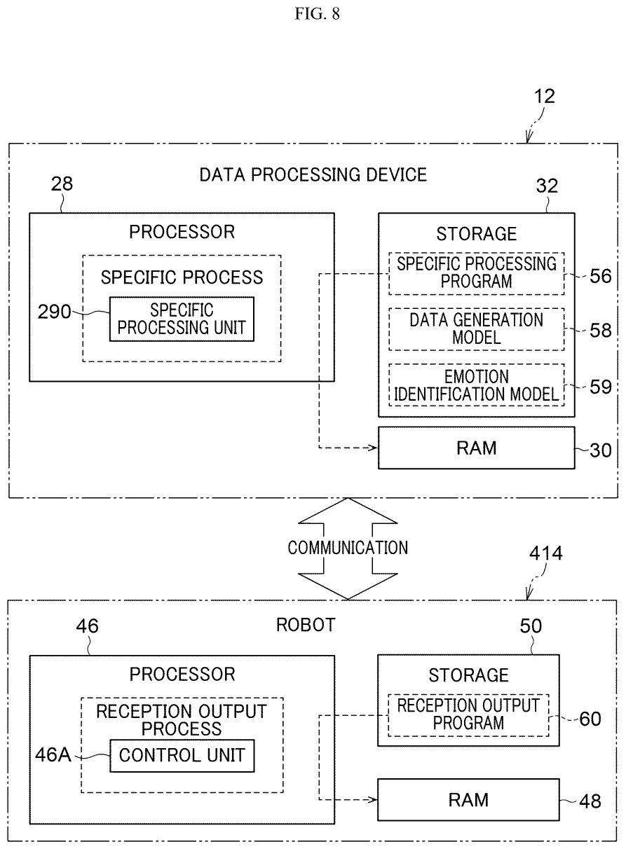

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

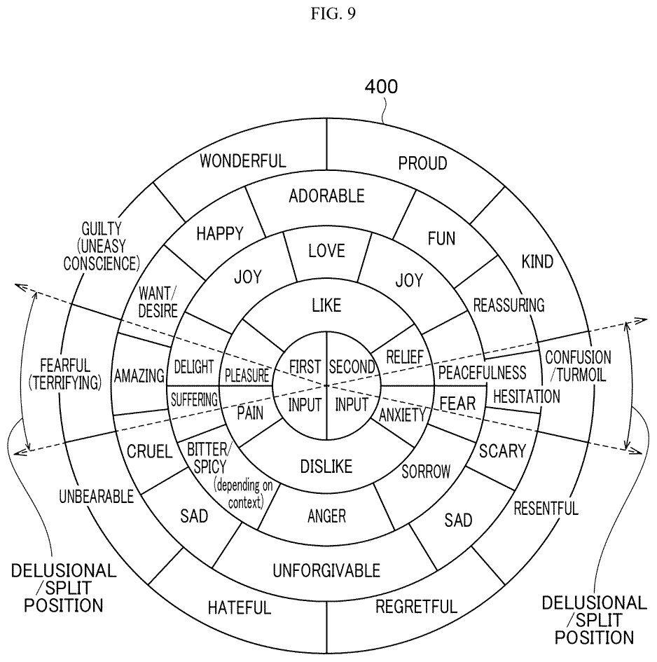

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

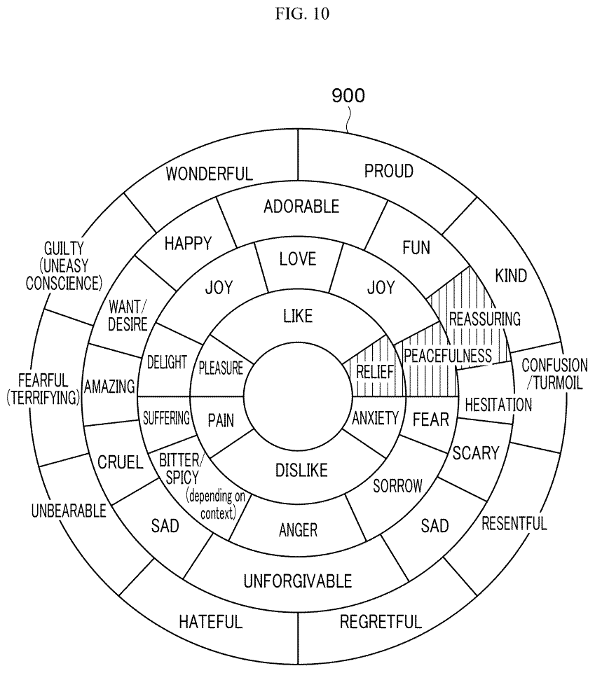

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire two-dimensional image information obtained by an orbital observation apparatus, perform preprocessing on the two-dimensional image information by using an image processing apparatus and an image processing program, the preprocessing including at least resolution adjustment and unnecessary region removal, to generate texture information suitable for three-dimensional shape representation,
generate or acquire three-dimensional shape information representing object shapes by using a three-dimensional shape generation program,
execute a mapping algorithm including projection transformation processing and coordinate transformation processing, based on the texture information and the three-dimensional shape information, to generate three-dimensional display information in which the texture information is associated with a surface of the three-dimensional shape information,
provide input information including a prompt sentence to a generative information processing model with respect to the three-dimensional display information generated by an information processing apparatus, obtain, from the generative information processing model, processing procedure information or control parameter information relating to at least a part of the mapping algorithm or the preprocessing, and control the mapping algorithm or the preprocessing based on the obtained processing procedure information or control parameter information, and
output three-dimensional video based on the three-dimensional display information to a display apparatus, analyze user behavior information or biometric measurement information during viewing of the three-dimensional video to estimate an emotional state of a user, and adjust display conditions of the three-dimensional video based on the emotional state.

### (Supplementary 2)

The system according to supplementary 1,
wherein the processor is configured to
constitute the three-dimensional display information as electronic information by using a content management program, transmit the electronic information to a distribution management apparatus via a communication network, associate price information or usage right information with the electronic information at the distribution management apparatus, publish the electronic information, and perform monetization processing by obtaining consideration information based on the publication.

### (Supplementary 3)

The system according to supplementary 1,
wherein the processor is configured to
dynamically update the three-dimensional video such that at least one of a viewpoint position, a magnification factor, a display target region, and a display parameter in the three-dimensional display information temporally changes in response to operation information input from the user.

### Application Example 1

### (Supplementary 1)

A system comprising a processor,
wherein the processor is configured to
receive two-dimensional image information acquired from a satellite, preprocess the two-dimensional image information by using an image processing program, and generate coordinate-aligned two-dimensional image information based on geospatial information, generate three-dimensional environment information by using a three-dimensional display program on the basis of the coordinate-aligned two-dimensional image information and three-dimensional shape information, and convert the three-dimensional environment information into a driving-assistance data format for an automated vehicle,
transmit the driving-assistance data format to a terminal, provide a prompt sentence to a generative artificial intelligence model including a machine learning model in the terminal by using the driving-assistance data format and in-vehicle sensor information as input information, and cause the generative artificial intelligence model to generate environment recognition information,
cause the terminal to generate display information including obstacle information and travel route information on the basis of the environment recognition information and the three-dimensional environment information, and output the display information to a display device so as to perform driving assistance for the automated vehicle, and
dynamically adjust content or a display mode of the display information on the basis of operation information or state information of a user.

### (Supplementary 2)

The system according to supplementary 1,
wherein the processor is configured to generate the prompt sentence to be provided to the generative artificial intelligence model in accordance with at least one of vehicle position information, time information, travel situation information, and operation information of the user, and to control a type and a level of detail of the environment recognition information based on the prompt sentence.

### (Supplementary 3)

The system according to supplementary 1,
wherein the processor is configured to cause the terminal to output the environment recognition information to a vehicle control computation unit, and to cause the vehicle control computation unit to execute at least one of steering control, acceleration and deceleration control, and warning control based on the environment recognition information.

### Example 2

### (Supplementary 1)

A system comprising a processor,
wherein the processor is configured to
receive, from a terminal device, two-dimensional image data and a prompt sentence expressed in natural language, and analyze a format, a resolution, a pixel count, and associated information of the two-dimensional image data to generate standardized image data,
provide, to a generative artificial intelligence model, a prompt based on the standardized image data and the prompt sentence, the prompt including content of the two-dimensional image data and conditions for generation of a three-dimensional shape, and obtain, from the generative artificial intelligence model, control information including structural parameters and material parameters of the three-dimensional shape,
execute a script that controls an application programming interface of three-dimensional shape editing software by using the control information and the standardized image data, and generate three-dimensional shape data in which the standardized image data is mapped as surface information, and
convert the three-dimensional shape data into a three-dimensional model file format usable in a virtual environment or an electronic game program, and provide the three-dimensional model file format in a state downloadable by the terminal device.

### (Supplementary 2)

The system according to supplementary 1,
wherein the processor is configured to
embed the three-dimensional shape data and the three-dimensional model file format into digital content, and provide the digital content and obtain consideration for the digital content via a distribution network service.

### (Supplementary 3)

The system according to supplementary 1,
wherein the processor is configured to
provide, again, a prompt to the generative artificial intelligence model in response to a user operation or an additional prompt sentence input from the terminal device, obtain updated control information from the generative artificial intelligence model, and dynamically adjust at least one of a shape, a material, and a display format of the three-dimensional shape data based on the updated control information.

### Application Example 2

### (Supplementary 1)

A system comprising a processor,
wherein the processor is configured to
acquire two-dimensional image data obtained from a satellite, generate a prompt sentence for a generative artificial intelligence model on the basis of the two-dimensional image data and attribute information associated with the two-dimensional image data, and obtain, from the generative artificial intelligence model using the prompt sentence, processing procedure information or control parameter information related to three-dimensional structuring and texture assignment of the two-dimensional image data; and
control an image processing unit and a three-dimensional shape generation unit on the basis of the processing procedure information or the control parameter information, generate three-dimensional shape data from the two-dimensional image data, generate three-dimensional representation data by mapping the two-dimensional image data onto the three-dimensional shape data, and further convert the three-dimensional representation data into a plurality of kinds of standard data formats or terminal-adapted data formats; and
acquire at least one of expression information, voice information, and operation information of a user, estimate an emotional state of the user by an emotion estimation processing unit, generate control information for dynamically adjusting at least one of a display control parameter, an audio control parameter, and an operation response parameter with respect to the three-dimensional representation data on the basis of the emotional state, and change in real time at least one of display characteristics, audio characteristics, and operability of the three-dimensional representation data on the basis of the control information; and
transmit, to the generative artificial intelligence model, a prompt sentence including the emotional state, behavior history information of the user, and attribute information of the three-dimensional representation data, and automatically redesign an update process of the display control parameter, the audio control parameter, and the operation response parameter on the basis of rule information or parameter optimization information acquired from the generative artificial intelligence model in response to the prompt sentence; and
distribute the three-dimensional representation data and the control information to a plurality of information processing terminals and execute distribution control for causing interactive presentation of the three-dimensional representation data on the plurality of information processing terminals.

### (Supplementary 2)

The system according to supplementary 1,
wherein the processor is configured to
receive three-dimensional shape data created by a user or acquired from an external device, convert the three-dimensional shape data into a same standard data format as the three-dimensional representation data, incorporate the three-dimensional shape data into an information processing program on the basis of the processing procedure information or the rule information acquired from the generative artificial intelligence model, provide the three-dimensional shape data as content through a distribution platform or an electronic commerce platform, and calculate revenue distribution information on the basis of usage result information or transaction information.

### (Supplementary 3)

The system according to supplementary 1,
wherein the processor is configured to
acquire operation information of the user and time-series change information of the emotional state from the information processing terminals, generate a prompt sentence for the generative artificial intelligence model on the basis of the operation information and the time-series change information, and dynamically update display control logic of the three-dimensional representation data, including at least one of viewpoint movement speed, magnification, response delay, emphasis of an attention target, and presentation of guidance information, on the basis of interaction design information acquired from the generative artificial intelligence model in response to the prompt sentence.

What is claimed is:

1. A system comprising:
circuitry configured to:
receive, via a communication interface coupled to a packet-switched network, two-dimensional image information obtained by an orbital observation apparatus, perform preprocessing including resolution adjustment and removal of unnecessary regions, and generate texture information suitable for three-dimensional shape representation;
generate or acquire three-dimensional shape data corresponding to the two-dimensional image information, generate a prompt sentence for a generative AI model to map the texture information onto the three-dimensional shape data, and cause the generative AI model to generate a three-dimensional model; and
analyze an emotional state of a user based on data received from a terminal device via the communication interface, adjust a display of the three-dimensional model based on the recognized emotional state, and transmit display data for the three-dimensional model to the terminal device via the communication interface.

2. The system according to claim 1, wherein the circuitry is configured to receive the two-dimensional image information from an orbital observation apparatus via the communication interface, perform resolution adjustment to standardize image resolution, and remove unnecessary regions to generate the texture information.

3. The system according to claim 2, wherein the circuitry is configured to generate three-dimensional shape data by executing a three-dimensional shape generation program based on the texture information, and store the three-dimensional shape data in a storage device.

4. The system according to claim 3, wherein the circuitry is configured to generate the prompt sentence incorporating the texture information and an instruction for the generative AI model to enhance or complete three-dimensional content based on the two-dimensional texture data, and input the prompt sentence to the generative AI model.

5. The system according to claim 4, wherein the circuitry is configured to receive the three-dimensional model generated by the generative AI model, apply post-processing to the three-dimensional model to generate a rendered output, and store the rendered output in the storage device.

6. The system according to claim 1, wherein the circuitry is configured to analyze the emotional state of the user by applying an emotion analysis engine to at least one of text input, vocal characteristics, and facial expression data received from the terminal device via the communication interface.

7. The system according to claim 6, wherein the circuitry is configured to adjust at least one of a rendering style, a color scheme, a level of detail, and a display orientation of the three-dimensional model based on the analyzed emotional state.

8. The system according to claim 1, wherein the circuitry is configured to dynamically adjust the display of the three-dimensional model in response to a user operation received from the terminal device via the communication interface.

9. The system according to claim 8, wherein the circuitry is configured to receive user operation data including zoom, rotate, and pan commands from the terminal device, update the display parameters of the three-dimensional model accordingly, and transmit updated display data to the terminal device.

10. The system according to claim 1, wherein the circuitry is configured to embed the three-dimensional model into digital content, generate distribution data for the digital content, and transmit the distribution data to a distribution platform via the communication interface.

11. The system according to claim 10, wherein the circuitry is configured to receive revenue data from the distribution platform via the communication interface, and store the revenue data in the storage device in association with the three-dimensional model identifier.

12. The system according to claim 1, wherein the circuitry is configured to receive updated two-dimensional image information from the orbital observation apparatus via the communication interface, generate updated texture information from the received image information, and regenerate the three-dimensional model using the updated texture information.

13. The system according to claim 12, wherein the circuitry is configured to detect changes between successive two-dimensional image information items received from the orbital observation apparatus, and selectively update only portions of the three-dimensional model corresponding to detected changes.

14. The system according to claim 1, wherein the circuitry is configured to generate a plurality of three-dimensional model variants by varying generation parameters in the prompt sentence, evaluate the variants based on a quality metric, and select a variant satisfying a quality threshold for transmission to the terminal device.

15. The system according to claim 14, wherein the circuitry is configured to compute the quality metric by comparing texture fidelity, geometric consistency, and rendering resolution of each variant against reference parameters stored in the storage device.

16. The system according to claim 1, wherein the circuitry is configured to receive, from the terminal device, a request specifying a geographic region of interest, retrieve two-dimensional image information for the specified region from the storage device, and generate a three-dimensional model of the specified region.

17. The system according to claim 16, wherein the circuitry is configured to combine three-dimensional models for adjacent geographic regions to generate a composite three-dimensional scene, and transmit the composite scene to the terminal device via the communication interface.

18. A system comprising:
circuitry configured to:
receive, via a communication interface coupled to a packet-switched network, two-dimensional image information from an orbital observation apparatus, perform preprocessing to generate texture information, and store the texture information in a storage device;
generate three-dimensional shape data, generate a prompt sentence for a generative AI model to map the texture information onto the three-dimensional shape data, and cause the generative AI model to generate a three-dimensional model;
analyze an emotional state of a user based on data received from a terminal device via the communication interface, and adjust a display of the three-dimensional model based on the analyzed emotional state; and
transmit display data for the three-dimensional model to the terminal device via the communication interface.

19. The system according to claim 18, wherein the circuitry is configured to dynamically adjust the display of the three-dimensional model in response to user operation data received from the terminal device via the communication interface, and embed the adjusted three-dimensional model into digital content for distribution.

20. A method comprising:
receiving, via a communication interface coupled to a packet-switched network, two-dimensional image information obtained by an orbital observation apparatus, performing preprocessing to generate texture information suitable for three-dimensional shape representation;
generating three-dimensional shape data, generating a prompt sentence for a generative AI model to map the texture information onto the three-dimensional shape data, and causing the generative AI model to generate a three-dimensional model; and
analyzing an emotional state of a user based on data received from a terminal device via the communication interface, adjusting a display of the three-dimensional model based on the analyzed emotional state, and transmitting display data to the terminal device via the communication interface.
